(19) United States
(12) Patent Application Publication
(10) Pub. No.: US 2007/0061166 A1
(43) Pub. Date: Mar. 15, 2007

(54) Techniques for improving loss ratios

(76) Inventors: Narayanan Ramasubramanian, Fremont, CA (US); Anand Subra, Plymouth, MN (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/511,703

(22) Filed: Aug. 28, 2006

Related U.S. Application Data
(60) Provisional application No. 60/712,751, filed on Aug. 29, 2005.

(51) Int. Cl. G06Q 10/00; G06F 19/00

(52) U.S. Cl. 705/2; 705/3

(57) ABSTRACT

Techniques and systems are described hereafter for reducing medical non-compliance by (1) developing the compliance-profile of a member, (2) using the profile to automatically generate a set of interventions, (3) categorizing, prioritizing and selecting the interventions, (4) incorporating the selected interventions into a personalized member user interface page, (5) serving the selected interventions to the member at the appropriate times via multiple channels, (6) observing and measuring member responses, (7) recording member responses in a database and analyzing the responses, (8) adapting the interventions, based on the analysis, to keep the member actively engaged, (9) escalating the interventions if the member response is inadequate, (10) updating the member's compliance profile based on analysis of the database, (11) providing member reports to authorized parties for purposes of paying member incentives, predicting member's utilization of high-cost healthcare services, etc., and (12) providing aggregate de-identified reports for purposes of predicting future risk reserve set asides, drug production and supply chain replenishment requirements.

### RELATED APPLICATIONS

This application claims priority to the following provisional applications, the entire contents of which are incorporated herein by this reference:

U.S. Provisional Patent Application No. 60/712,751 filed by Narayanan Ramasubramanian on Aug. 29, 2005, entitled “Techniques for Improving Loss Ratios”.

### FIELD OF THE INVENTION

The present invention relates to improving loss ratios and, more specifically, to improving medical compliance. Medical compliance consists of the following: (1) wellness compliance, or actively participating in programs designed to keep people healthy (diet, exercise, weight management, stress management, smoking cessation, etc.), (2) screening compliance: getting screened for certain diseases based on age, gender, race and other risk factors as per medical guidelines, (3) patient compliance, or filling/refilling and consuming medications as prescribed, and (4) treatment compliance, or going for specific condition-based treatments as prescribed.

### BACKGROUND

Based on age, gender, genetic background, lifestyle and other health risk factors, people generally have health problems and chronic illnesses at different points in their lives (ref 1: CDC, WHO, ADA, etc. disease prevalence stats). Some of the risk factors are modifiable. By intervening appropriately to reduce the modifiable risk factors, we can improve overall health outcomes, delay or even prevent the onset of diseases, and thus reduce healthcare expenses. The reduction in healthcare expenses leads to an improvement in the loss ratio (ref 2. definition of loss ratio) for organizations that collect premiums and pay for these expenses. If the paying organization is an employer, the reduction represents savings.

According to this invention, the key to reducing health risks is improving medical compliance (defined above). Since treating diseases in their early stages is much more effective and cheaper, proper screenings can reduce costs by detecting emergent diseases before they become overt problems. For people who have not been diagnosed with any disease, but may be at risk, the objective is to keep them healthy by improving their participation in wellness and prevention programs. These programs delay or even prevent the onset of chronic diseases. Once diseases have taken root, however, wellness and prevention are not enough; medications or treatments become necessary to keep diseases under control. Thus, for people who have been diagnosed with disease(s), the objective is to retard or prevent the natural progression of the disease(s) by improving their medication or treatment compliance, in addition to improving their participation in wellness and prevention programs.

Medication compliance (also known as patient compliance) is characterized in terms of what the patient does after receiving a prescription from the doctor or nurse. Studies show that around 14 percent (ref3: medication compliance BCG study) do not even fill the prescription at a pharmacy, and overall medication compliance is only around 50 percent (ref4: medication compliance stats). Medication non-compliance takes place in various modes: missed drug, wrong drug, missed dose, wrong dose, or wrong time. Any of these modes would make the drug-taking different from the controlled conditions of the clinical trial under which the drug's efficacy has been established. Thus the patient, taking the drugs in these non-compliant modes would not experience the expected health outcomes to the same level of effectiveness.

There are several reasons why medication compliance is so low. According to a detailed study of non-compliance (ref3 BCG study), patients: (1) forget, (2) cannot get prescriptions filled or delivered, (3) do not want the side effects, (4) cannot afford the drug, (5) do not think they need the drug, or (6) do not know how to use the drug. Other cited reasons include personal feelings or beliefs (ref 5 www.healthpages.com), such as: (1) “I don't have symptoms”, (2) “I feel fine”, (3) “I am not convinced I need the drug or of the drug's benefit”, (4) “It can't happen to me”, (5) “I am afraid to take the drug because of adverse effects”, (6) “the side effects are too uncomfortable”, (7) “I can't remember to take the drug”, (8) “The drug is too expensive”, (9) “I think my health problem has been fixed”—and discontinue drugs as soon as they feel better, or (10) “If more is better, let me increase the dosage to speed up the cure”.

Current interventions predominantly address a single reason for non-compliance. For example, there are several ‘reminder’ services that automatically send a voice or SMS message to the individual's cell phone at the appropriate times of day to remind him or her to take their medicine. This is very useful for individuals who tend to forget, but only an irritant for those who are quite regular and don't forget. Another example is the suspension, by health plans, of co-pay or co-insurance for drugs that are used to control certain diseases, such as diabetes, in an effort to get individuals to at least fill their prescriptions (the hope is that they will later take the medicines as prescribed). This may help diabetics who are currently not filling their prescriptions because of cost considerations, but it may not be necessary for diabetics who can afford the copays and were going to fill their prescriptions anyway. Further, this only removes the cost barrier for diabetics to fill their prescriptions. It does not necessarily influence or enable them to take them as prescribed, at the right times and dosage strengths. In addition, there is no feedback loop to confirm that individuals are indeed taking the drugs as prescribed. A combination of the above two interventions might be quite effective for diabetics who not only have financial constraints that keep them from filling their prescriptions, but also tend to be forgetful. Thus, even with two potential interventions, we can see that the effective applicability can be quickly narrowed down to a small subset of individuals.

In general, there are hundreds of potential interventions and each intervention only works for a small segment of the population, at a particular time, so any single intervention will only have a small impact on overall compliance. This invention seeks to overcome this drawback by personalizing the interventions to the individual, and adapting the interventions as the individual's needs change.

There are yet other reasons for poor compliance, and these are very specific to individual patients. In terms of the ‘State of Health’, the reasons for non-compliance are different depending on the disease, whether it is hypertension, high cholesterol, depression, MS, and so on. In terms of the ‘Health Beliefs’, compliance depends a lot on the patient's perceived susceptibility, severity, barriers, benefits, cues to action, trust in doctors, trust in medicines, and so on. In terms of behavioral ‘Stage of Change’, much depends on whether patients acknowledge their health issues or are in denial; specifically on whether they are in ‘Pre-contemplation’, ‘Contemplation’, ‘Decision’, ‘Action’, or ‘Maintenance’ stages. Demographics also play a key role; age, gender, race, income, family size, family arrangements, education, and so on have an impact on the level of compliance. Personal factors, such as caregiver availability, type of job, hobbies, travel patterns, daily commute, personality type, inertia level, desire for secrecy and peer influences, enter into the picture as well.

These reasons are not only very specific to individuals, but they also vary over time for the same individual, since at any particular time, the individual is subject to various situational factors. These factors interact with the individual's current behavioral state and health beliefs, and produce a current level of receptivity to specific types of influences and information. Given this, merely transmitting pre-planned messages, even if they are somewhat personalized, has a reduced chance of being received and acted upon by the subject individual. If the individual does not consider the message or content to be relevant or of value, he or she may simply ignore it, or worse, tend to ignore subsequent messages from the same source—this is all well-known. In order to maximize the chances of being received and acted upon, a main goal of this invention is to provide timely interventions that are highly personalized, relevant and matched to each individual's current behavioral stage.

Effecting change in behavior, such as going for health screenings, participating in wellness activities or medicine-taking, requires a consistent set of messages to get through to the subject individual for a certain length of time, at a frequency that keeps the messages from being forgotten. Studies on memory formation and forgetting are useful in setting the intervention frequency, and the often-cited cybernetic view that it takes three weeks for a new habit to develop is also useful in setting the duration of interventions. Thus not only do the interventions (that convey the messages) have to be highly personalized, relevant and matched to the current behavioral stage, they must also be provided at a frequency that maximizes the likelihood of being received and not ignored. If the interventions are too frequent, the individual may turn them off, considering them a nuisance. On the other hand, interventions that are too infrequent have limited or no effect in changing the behavior. Interventions must provide some value to the individual, such as imparting interesting information, pointing them to useful hints and tips, and so on. Also, the content must be fresh and engaging—the same content repeated multiple times loses the effect. Accordingly, another goal of this invention is to select the interventions such that relevant, but possibly different, content is provided at different times. Yet another goal is to match the frequency of the interventions to the individual's preferences at a particular time.

Personalization of interventions based on static knowledge about the individual is a good starting point, but the impact is rapidly lost if the personalization is not refreshed based on the individual's response. Continuing to send interventions similar to those that have been ignored or dismissed by the individual serves no useful purpose and may even alienate the individual. On the other hand, avoiding these interventions can help. Modeling future interventions around those to which the individual has responded positively, is more likely to sustain the interest and level of engagement of the individual. Accordingly, a goal of this invention is to seek individual responses to interventions, in terms of usefulness, relevance, value etc., and to use these responses to model and adapt further interventions.

Existing approaches to improve compliance in general do not concern themselves with what happens after the patient fills the prescription; in other words, compliance equals ‘possession’. However, what matters to good health outcomes is not whether the patient fills the prescription, but whether the patient actually takes the medication as prescribed. Accordingly, this invention seeks to improve compliance in terms of how well the patient follows the prescription, i.e., whether the right drug was taken at the right time, at the right dosage, and whether all the prescribed drugs were taken.

Some approaches provide interventions in the form of a one-time plan generated on the basis of static information about the patient. The patient is required to perform the activities in the plan, and there are periodic (e.g. quarterly) follow-ups. Issues of cost due to the reliance on expensive nurse labor may dictate this infrequent follow up. It is known that interactive and frequent interventions work better, so while these approaches are getting some results, much more results are possible with more frequent and personalized follow up. This invention, as mentioned previously, seeks to provide interventions frequently enough to change behavior, but limits the frequency to individual patient preferences in order to minimize the chances of being ignored.

Another drawback of existing approaches is that the emphasis is on ‘telling’ the patient what to do, and not on ‘motivating’ the patient to take charge of their own health. ‘Telling’, especially in strong terms indeed has an impact on compliance, but it disappears soon after the intervention is removed. Change in behavior resulting from being motivated has a sounder basis and thus has a better chance of maintaining itself as circumstances change. Accordingly, another goal of this invention is to first understand the ‘stage of change’ (ref 6 Prochaska) of an individual in terms of target health behaviors (such as medicine-taking or going for health screenings or participating in weight-loss or smoking-cessation programs), then construct a personalized intervention plan.

As an example, if an individual is not even thinking about going for health screenings, he needs to be influenced to do so, using interventions with compelling content designed to increase his perception of susceptibility to disease because of age, gender, ethnicity, lifestyle, etc. The objective is to move the individual to the point of thinking about the target behavior; once this objective is achieved, yet another set of interventions might serve to move the individual to the subsequent action stage, and so on. Thus by using different sets of interventions targeted at different stages of change, the individual is moved forward (i.e. motivated) towards self-efficacy, or taking charge of their own health.

Since behavioral change is difficult, an individual may not respond sufficiently; when this happens, it is necessary to escalate the interventions or content in an attempt to increase the responsiveness. A different set of interventions, featuring content designed to increase his perception of seriousness, i.e., what can happen if he lets it go for too long, and so on. A good example of content in this regard is the TV commercial of a young man who has gone blind because he neglected getting screened for diabetes. Accordingly, another goal of this invention is to provide a method by which interventions are escalated automatically, based on member response.

Interventions that involve personalized, human-interactions with individuals have so far been the most successful of the different approaches in current use—nurses or other qualified persons contacting individuals by phone or email on a regular basis to ask questions about heath, symptoms, side effects, adverse effects and so on. Coupled with these questions is some motivational interviewing designed to improve medication or treatment compliance. Due to the high cost of nurse-labor, these interventions are reserved for the sickest patients who might otherwise end up in the emergency room or hospital, and are not made available to the moderately-ill or healthy population. Additionally, a very large number of nurses would be needed to handle the latter population, at a time when there is a significant national nursing shortage, which makes this type of labor-intensive interventions impractical—it is inherently non-scalable to large populations.

Existing approaches to improving health can be categorized into: (1) nurse-labor-intensive, highly personalized ‘case management’ interventions for the highest-risk patients, (2) marginally personalized mass-produced ‘disease management’ interventions for the lower-risk patients, and (3) voluntary, self-service ‘wellness management’ programs for the healthy population. The highly personalized interventions have been shown to work well, and will likely do so for the lower-risk and healthy populations in improving medical compliance. However, because of the dependence on skilled nurse labor, these interventions are both expensive and non-scalable for these populations.

There is thus a need for an approach that can: (1) provide deeply personalized, motivational support, (2) frequent interventions at low cost, and (3) be scaled-up to service the demands of a large population of healthy and medium-risk patients. This approach would keep the medium-risk patients from deteriorating towards high-risk and the healthy population from deteriorating towards medium risk. The objectives of this invention are to address these needs. Doing so would significantly reduce the estimated $100 billion annual costs of treating medical problems due to non-compliance in the US alone. In addition, improving compliance would recapture some of the $30 billion worth of unfilled prescriptions every year, and thus increase pharmaceutical industry revenues. Accordingly, a key goal of this invention is to provide a deep level of personalization and adequate frequency in the interventions, but at greatly reduced cost, through automation. A further goal is to eliminate the barriers to scalability, also through automation.

U.S. Pat. No. 5,642,731 monitors the disease process and health of a patient undergoing drug treatment by using a microprocessor embedded in a drug dispenser to record a variety of clinical information such as symptoms, side effects, adverse drug reactions and so on. It seeks to improve disease management by capturing the date and time of the dosage, analyzing the data and downloading instructions to alter patient behavior in taking medication. This invention mechanizes the recording of when patients are opening the medication containers to ostensibly take their medicines, as well as the recording of clinical information, so it addresses the need for recording actual compliance. However, it does not address the motivational issues around taking the medications—patients may take the medicine as long as this invention is present and stop thereafter, or they may go through the motions of opening the container but not actually ingest the medications. Further, they may not accurately enter all the information required.

U.S. Pat. Nos. 6,234,964 and 6,770,029 describe a system that performs disease management in a fully automated manner using periodic interactive dialogs with the patient to obtain health state measurements, to assess the patient's disease and adjust therapy, and to give the patient medical advice. They also describe features and a metric based on subjective and objective health measurements that are used to tailor disease management interventions to individual patients. The system builds a profile of the frequency and patient's reasons for using the system, understanding of the disease, response to various treatments and preferences. The system interacts with patients through regularly scheduled sessions. This invention automates the traditional approach to following up on patients with chronic diseases—gauging health status, risks, clinical results, etc. and developing therapy-oriented intervention plans.

U.S. Pat. No. 6,974,328 describes an adaptive interactive teaching system for the remote education that selects and provides lessons based on a patient's profile. The lessons offer the patient information reflecting the patient's health, and offers the patient's healthcare provider information regarding the patient's study of the lessons, the patient's health, and the patient's medical appointments.

In general, the above-mentioned examples address specific parts of the overall problem and are lacking in the depth of personalization, frequency of intervention, obtaining and incorporating feedback from members and in adapting to the changing needs of the individual members. The system described hereafter introduces novel elements and builds on some of the existing solutions, or parts thereof, and provides a more comprehensive solution.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart that shows the major steps in the method for improving medical compliance, according to one embodiment.

FIG. 2 shows the member registration process, data inputs and storage in databases.

FIG. 3 shows the member factors and their storage in databases.

FIG. 4 shows the member demographics mapping.

FIG. 5 and FIG. 6 show the mapping of member data to factors.

FIG. 7 shows various compliance events and their mapping to the member calendar.

FIG. 8 shows the mapping of member factors to expected behaviors.

FIG. 9 shows the intervention model.

FIG. 10 shows the content model.

FIG. 11 shows the mapping of member factors and data to interventions.

FIG. 12 shows the consolidation of like interventions.

FIG. 13 shows the method by which interventions are composed.

FIG. 14 shows the composition of a personalized web page.

FIG. 15 describes the intervention portal.

FIG. 16 is a flowchart that describes the intervention service model

FIG. 17 is a flowchart that describes the escalation model.

FIG. 18 is a flowchart that shows the different analytics derived by the system.

FIG. 19 describes the system integration database.

FIG. 20 is a flowchart that describes how the credibility score is derived.

FIG. 21 shows the different stages of compliance.

FIG. 22 and 23 are flowcharts that describe how the compliance slope is derived from two different sets of measurements.

FIG. 24 is a flowchart that describes the Compliance score calculation.

FIG. 25 shows the inputs to the PurpleTeal Score.

FIG. 26a describes the intervention adaptation model.

FIG. 26b describes the intervention frequency adaptation model.

### DETAILED DESCRIPTION

### OVERVIEW

Techniques and systems are described hereafter for reducing medical non-compliance by (1) developing the compliance-profile of a member, (2) using the profile to autiomatically generate a set of interventions, (3) categorizing, prioritizing and selecting the interventions, (4) incorporating the selected interventions into a personalized member user interface page, (5) serving the selected interventions to the member at the appropriate times via multiple channels, (6) observing and measuring member responses, (7) recording member responses in a database and analyzing the responses, (8) adapting the interventions, based on the analysis, to keep the member actively engaged, (9) escalating the interventions if the member response is inadequate, (10) updating the member's compliance profile based on analysis of the database, (11) providing member reports to authorized parties for purposes of paying member incentives, predicting member's utilization of high-cost healthcare services, etc., and (12) providing aggregate de-identified reports for purposes of predicting future risk reserve set asides, drug production and supply chain replenishment requirements.

### MEDICAL COMPLIANCE MANAGEMENT SYSTEM OVERVIEW

A comprehensive system for reducing medical non-compliance is described. The system includes: (a) registration and data entry (b) personalization (c) a portal to serve interventions via multiple channels, (d) methods to capture member compliance information, (e) a portal to receive compliance information and to provide secured user access, (f) a secured database to hold the member compliance and other records, (g) methods for handling non-response to interventions, and (h) individual and aggregate analytics The system and its elements are described below.

### OVERVIEW OF FIGURES

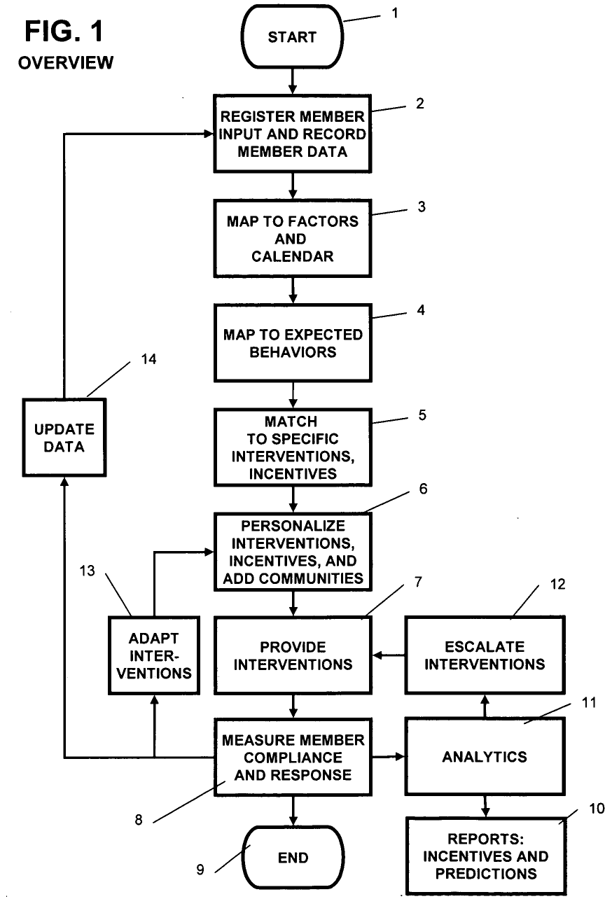

FIG. 1 shows the major steps in the method for improving medical compliance, according to one embodiment. Starting with 1, a member is first registered in the system and member data is collected and stored in the system in step 2. In step 3, the member data are mapped to several member factors that have a bearing on compliance behavior. In the subsequent step, 4, the member factors are mapped to expected behaviors from the member; these behaviors include compliance-related behaviors such as going for medical screenings, taking medications on time and so on. For example (ref 8 www.cdc.gov/nchs/nhis.htm) the Centers for Disease Control (CDC) states that ‘the likelihood that a woman has had a mammogram at some time in her life varies by race/ethnicity. Hispanic women were the least likely to have ever had a mammogram, whereas non-Hispanic white women were the most likely.’ Thus a Hispanic woman can be expected to have higher screening non-compliance, and will therefore need to be influenced to a greater extent to get a mammogram. This type of expected behavior is the basis for matching a set of specific interventions and incentives to the member in step, 5, that are designed to influence and enable the member to act (in this case, to get a mammogram). In step 6, the selected interventions and incentives are personalized, and relevant on-line community links are added and all the interventions are consolidated into a member-specific intervention plan. Personalization involves modifying the interventions to suit the member's preferences and requirements. An intervention has several parameters such as channel, tone, frequency, and so on—these are described in detail in a later section—these are preset based on the expected behaviors. In step 7, the intervention plan is converted into a set of instructions that transmit the interventions to the member through the portal. Once the interventions have been provided, the system monitors the responses in order to obtain member feedback and measure compliance, in step 8. This ends the top to bottom flow. A number of analytics, 10, are provided, based on the member responses, feedback and measurements—which are described in a later section. One set of analytics provides the information to generate reports, 11, and trigger the escalation of interventions, 12.

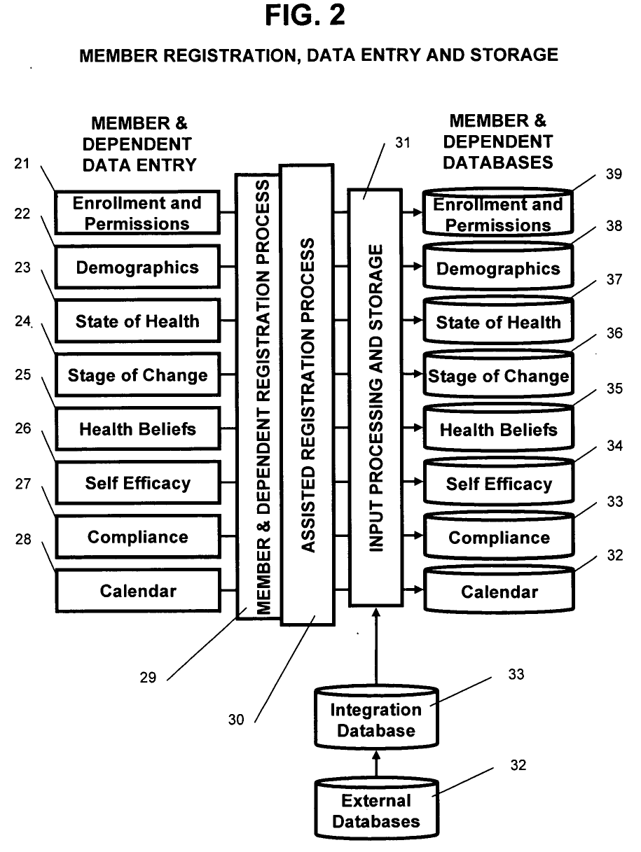

With reference to FIG. 2 which shows the member registration process, data inputs and storage in databases, the following are described. Members are first required to enroll and indicate permissions 21 for access to their health information, subject to the applicable laws; they are also required to enter certain personal and contact information. In addition, they are required to electronically indicate agreement with the terms and conditions of use, and to acknowledge that they understand the disclaimers. This is common internet practice. Following this, members are asked to enter detailed information about themselves 22, and answer some questionnaires 23 to 27. A calendar 28 is also provided for direct entry of events. The primary mode of data entry is through the internet, using a website 29. However, in cases where the member is unable or incapable of entering the data directly on the website, an assisted registration process 30 is invoked, in which a paper copy of the entry screens and questionnaires is provided, and a third party will specifically be authorized to enter the data into the system through the website 29. Alternatively, a member may enroll and enter the data for dependents. In the following, the words ‘member’, ‘patient’ and ‘dependent’ are used interchangeably. The entered data about a member is next stored in member-identified databases 32 to 39. With the proper permissions, authorizations and safeguards in place, some member data may be imported from external databases 32 such as those of health plans, employers or providers, using the integration database 33. These databases may optionally be consolidated into a single member database.

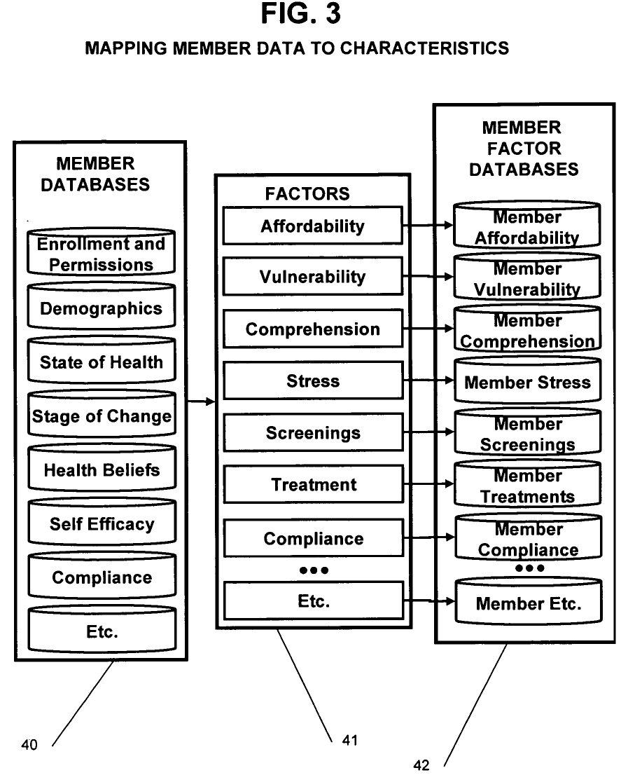

Referring to FIG. 3, which shows the mapping of the data in the member database(s) 40 to certain member ‘Factors’ 41, the raw data collected about a member is correlated with the factors. The member factors are determined from these correlations and subsequently stored in the factor database(s) 42.

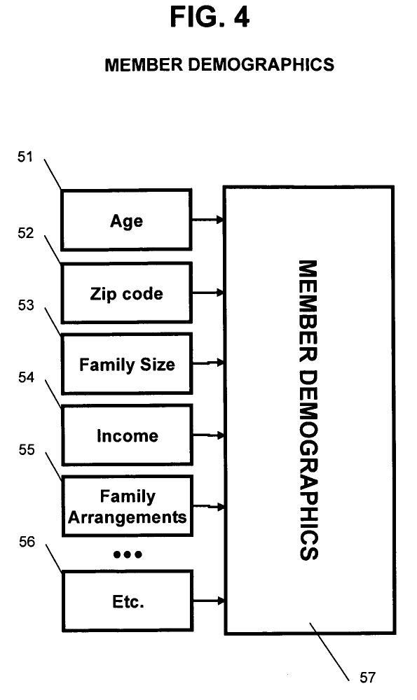

In FIG. 4, some of the member demographical data elements are identified. The intent in this and the following figures is to provide clarity by limiting the number of data elements or factors shown; there may be additional data or factors that are included in the ‘Etc’ category; this should not be viewed as a limitation of any kind. Some examples shown include: Age 51, Zip code of residence 52, Family size 53, Household income 54, Family arrangements 55, etc. 56.

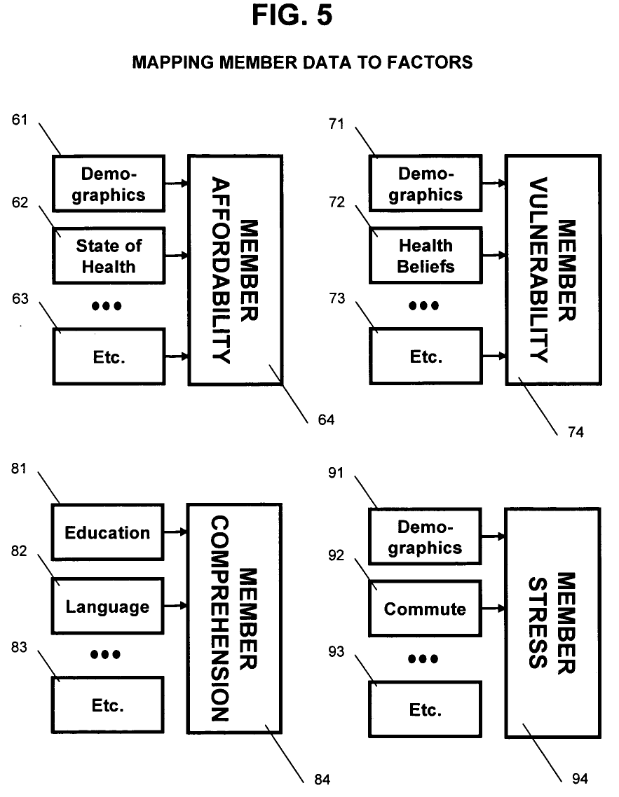

FIG. 5 shows the mapping of member data to the factors: Affordability 64, Vulnerability 74, Comprehension 84, Stress 94, Screening 104, Treatment 114, Communities 124 and Incentives 134. In each case, only a subset of the data mapped to the factors is shown for brevity, and this should not be construed as a limitation of any kind. For example, Affordability is shown as being mapped from demographics 61 and state of health 62, but there are other data that have not been specifically enumerated here, but are included in the box labeled ‘Etc.’ 63. Similarly Vulnerability 74 is mapped from demographics 71, health beliefs 72 and other data included in ‘Etc.’ 73. Comprehension 84 is mapped from education 81, language 82 and other data included in ‘Etc.’ 83. Stress 94 is mapped from demographics 91, commute 92 and other data included in ‘Etc.’ 93.

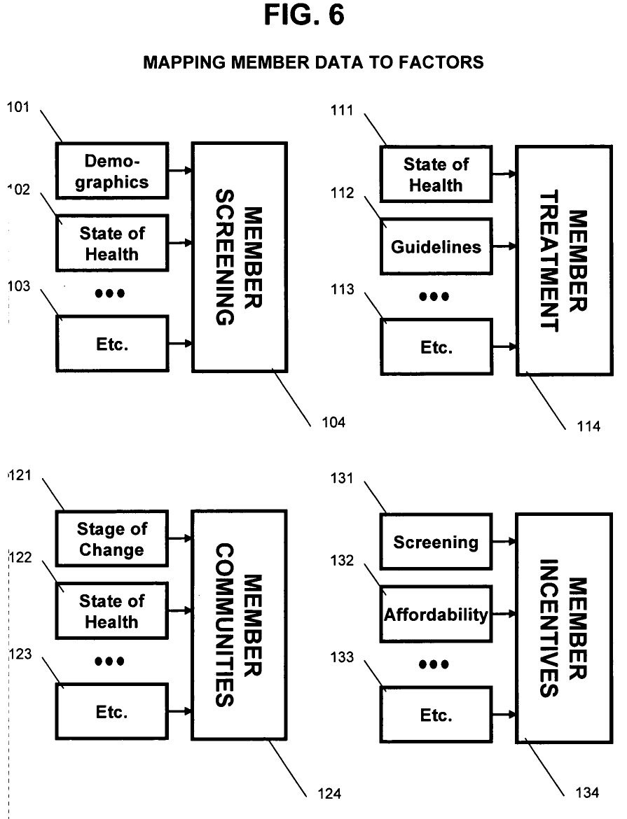

FIG. 6 shows the mapping of member data to additional factors. Screening 104 is mapped from demographics 101, state of health 102 and other data included in ‘Etc.’ 103. Treatment is mapped from state of health 111, guidelines 112 and other data included in ‘Etc.’ 113. Member communities 124 are mapped from stage of change 121, state of health 122, and other data included in ‘Etc.’ 123. Member incentives 134 are mapped from screening 131, affordability 132 and other data or factors included in ‘Etc.’ 133.

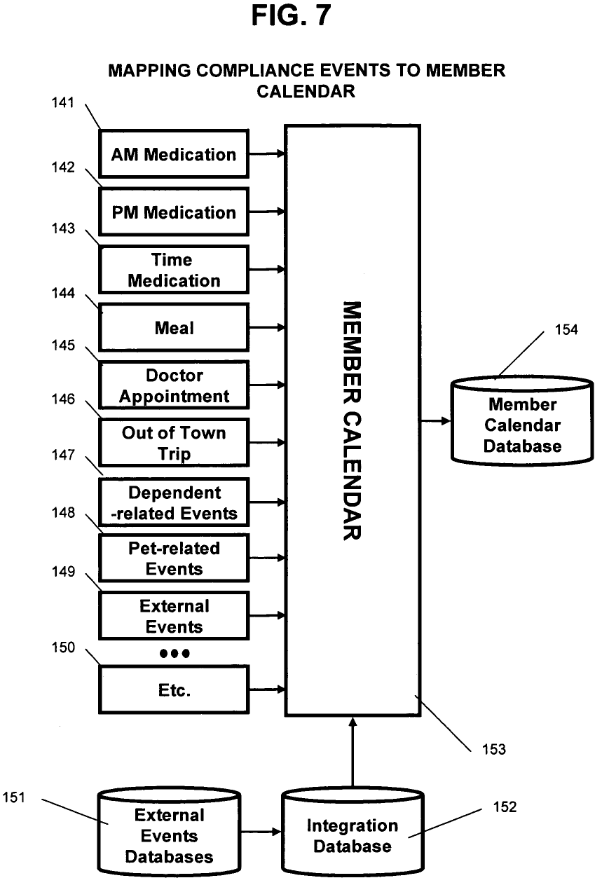

FIG. 7 shows various compliance events and their mapping to the member calendar 153 and then stored in the member calendar database 154. The events include: AM (morning) medication 141, PM (evening) medication 142, medication at a set time 143, meal 144, doctor appointment 145, out of town trip 146, events related to dependents 147, events related to pets 148, external events 149 imported from external sources or created by the member, and others included in ‘Etc.’ 150. The external events databases 151 may reside on other internet sites; the data from these sites are imported into the integration database 152 and used to populate the member calendar 153. Events can be entered or modified by the member at various times by accessing the system as authorized. Once entered, the events are stored in the member calendar database 154.

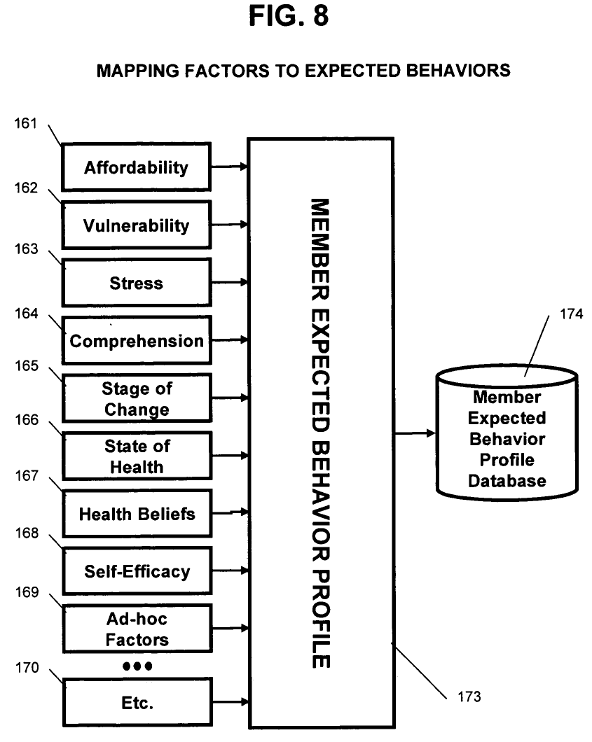

FIG. 8 shows an embodiment of the mapping of member factors 161 to 170 to expected member (compliance) behavior profile 173. The mapping analyzes the member factors and develops a profile of expected member behaviors 173. As mentioned above, the CDC finding that a Hispanic woman is less likely to get a mammogram is an example of expected behavior based on the vulnerability factor 162. Another expected behavior is based on the affordability factor 161 is that a member with a household annual income of less than $50,000 is less likely to fill an expensive prescription. Such individual expected behaviors are consolidated to develop the member expected behavior profile 173, which is subsequently stored in the member expected behavior profile database 174.

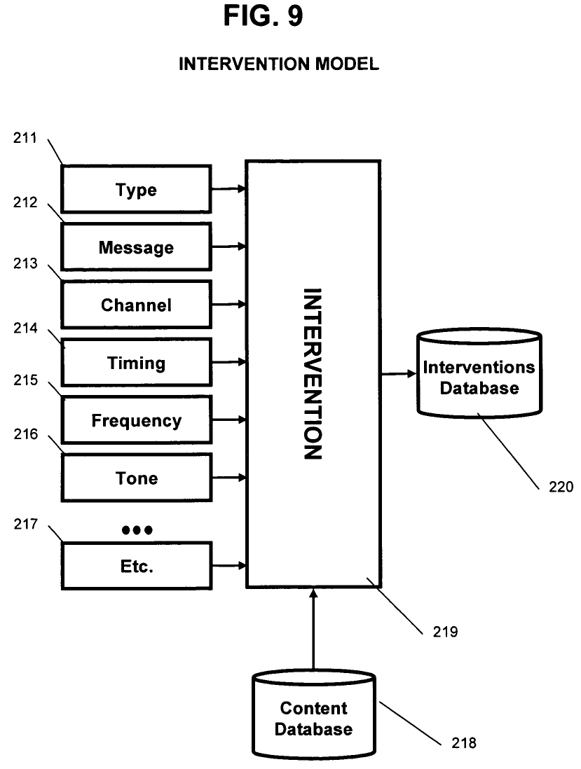

FIG. 9 shows the intervention model. An intervention 219 has several aspects and parameters 211 to 217. The purpose of an intervention is to successfully convey relevant and valued content 218 to or from the member. Interventions can be of different types 211 (influencing or enabling or measuring, mandatory or supplementary, time-based, count-based or day-based), convey different messages 212, use different channels 213, at different timings 214, with certain frequency 215, with the proper tone 216 that conveys urgency or importance, and other aspects included in ‘Etc.’ 217.

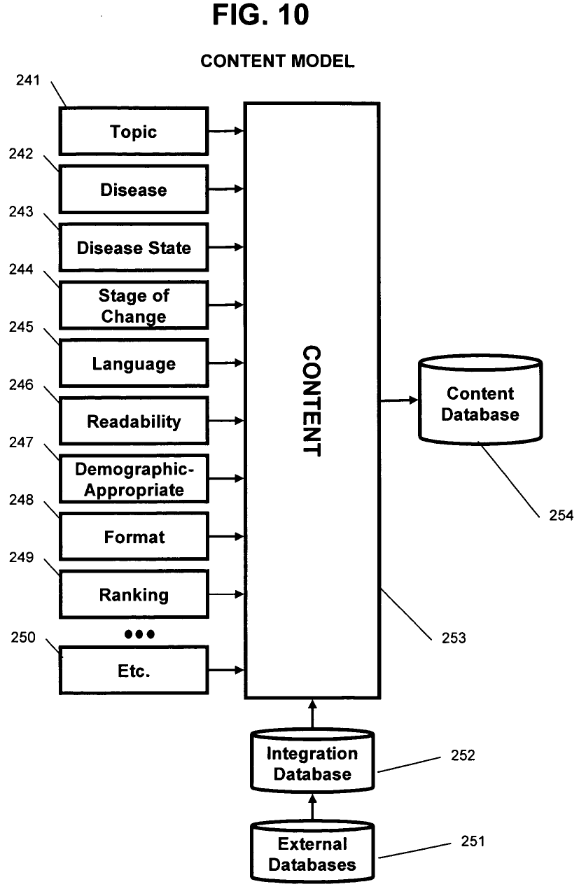

FIG. 10 shows the content model. Content 253 is comprised of the raw information that is to be conveyed to the member. The information can pertain to a topic 241, be related to a disease 242 or disease state 243, or to a stage of change 244. The information may be in a certain language 245 and at a ‘less or more than 8^{th} grade’ readability level 246. The information may be oriented towards certain demographics 247, such as pictures of children, young adults, middle-aged people etc. that children, young adults etc., would better relate with. The information may also be age-appropriate such as avoiding intensely graphic images for those below 13 years of age. The information may also be present in multiple formats 248 in order to facilitate transmission via multiple channels. The content may also be ranked 249 in terms of usefulness to members, based on collective feedback. Other attributes of the content model are included in ‘Etc’ 250. Content may be imported from external databases 251 using the integration database 252.

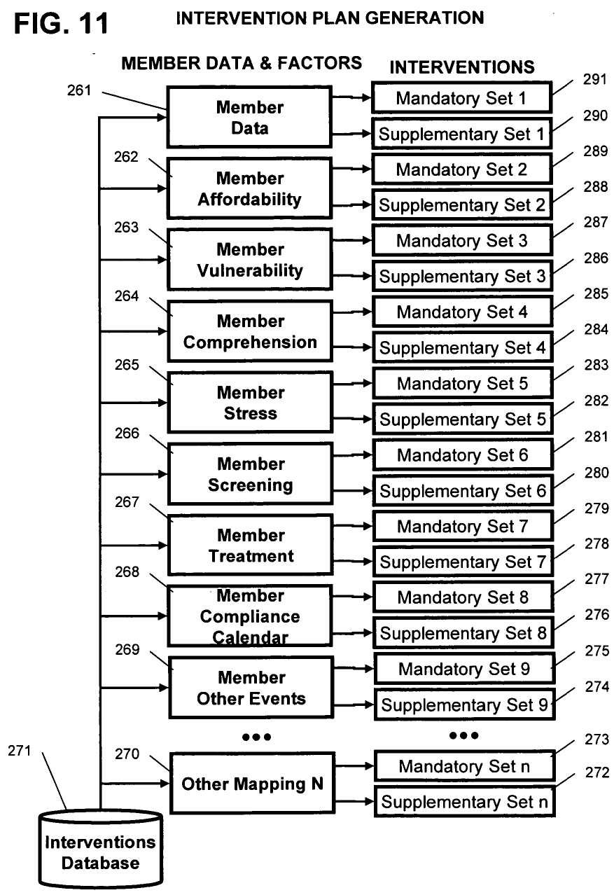

FIG. 11 shows an embodiment of the automatic generation of specific mandatory interventions 273, 275, 277, 279, 281, 283, 285, 287, 289 and 291 and supplementary interventions 272, 274, 276, 278, 280, 282, 284, 286, 288 and 290 based on member data and factors. Mandatory interventions cannot be deleted by the member, but they can be modified. Supplementary interventions can be deleted or modified by the member. Typically mandatory interventions require a response or measurement from the member while supplementary interventions serve to influence and enable behavior. Member data 261, such as state of health, which identifies the member's diagnosed diseases, ensure that only interventions relevant to the member's selected diseases are generated. Member factors, calendar, events and other mappings 262 to 270 generate several mandatory and supplementary interventions. For example, the member affordability 262 factor may generate mandatory interventions for free screening events or supplementary interventions for options to get medication copays waived or reduced, for a member with low affordability. The vulnerability 263 factor may generate mandatory interventions for cholesterol and diabetes screening based on member demographics and risk factors.

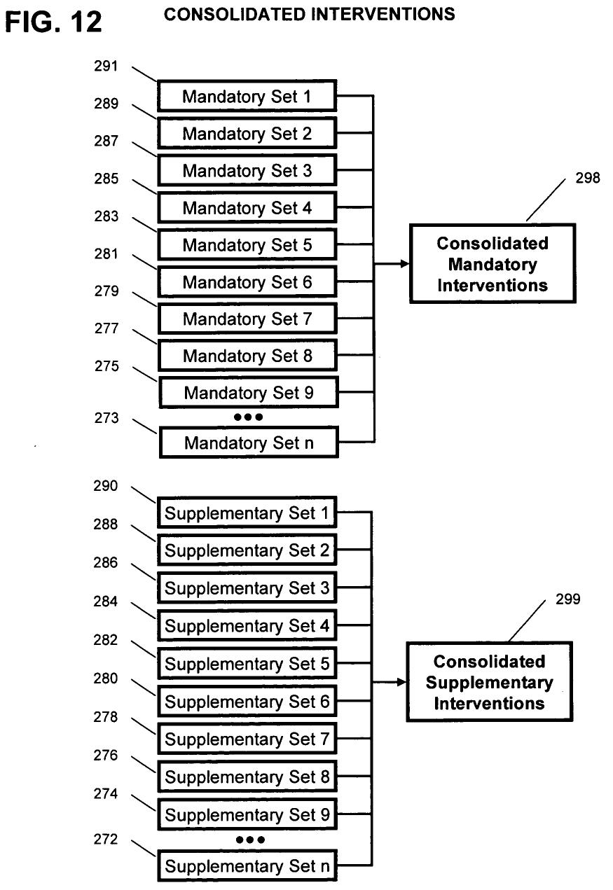

FIG. 12 shows an embodiment of the consolidation of like interventions. The generated mandatory interventions 273, 275, 277, 279, 281, 283, 285, 287, 289 and 291 and supplementary interventions 272, 274, 276, 278, 280, 282, 284, 286, 288 and 290 are consolidated into like groups—mandatory 298 and supplementary 299.

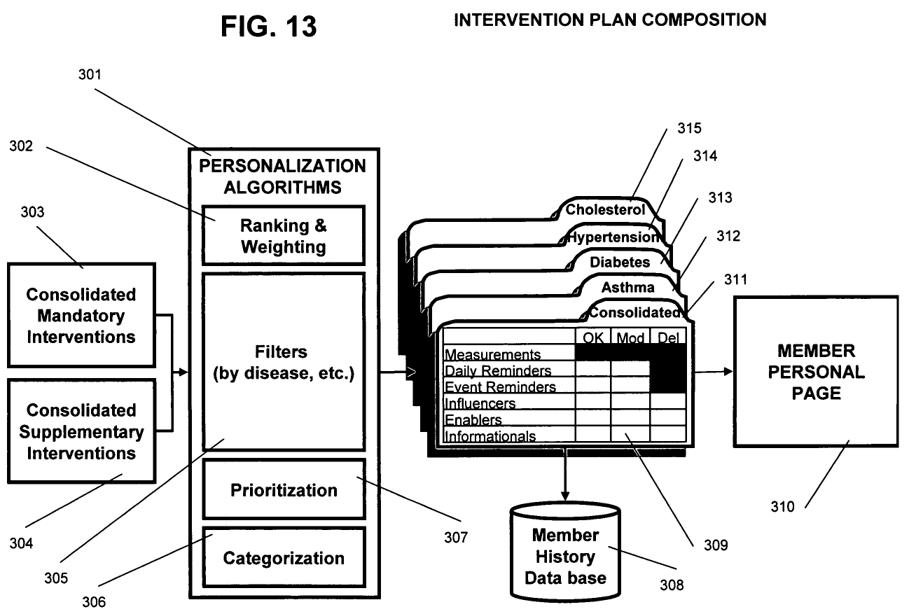

FIG. 13 shows an embodiment of the method of composition of the intervention plan. Given the consolidated mandatory interventions 303 and supplementary interventions 304, personalization algorithms 301 are used to automatically rank and weight 302, filter 305, prioritize 307 and categorize 306 the interventions. The result is a set of ranked interventions 309 categorized by disease and presented for each disease that is applicable to the member, for example asthma 312, diabetes 313, hypertension 314 and cholesterol 315. These interventions comprise the member's intervention plan that becomes part of the member's personal page 310.

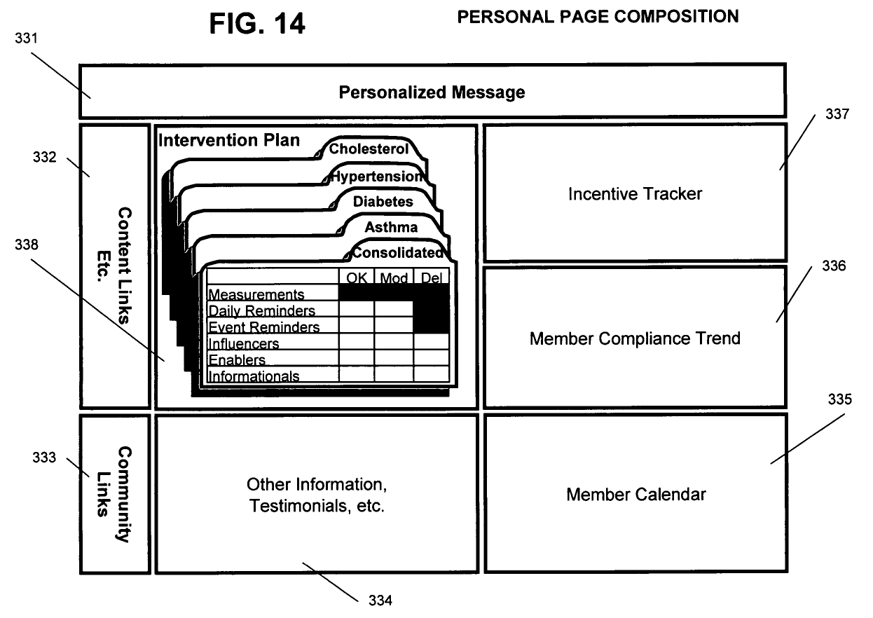

FIG. 14 shows an example composition of the personal web page. The objective of the personal page is to present a member with the information, actions, enablers and links that are most likely to elicit a response from the member. Each member will have a unique page that is generated from the data provided by the member. In one embodiment of this invention, the personal will have a personalized message area 331, relevant content links 332, relevant community links 333, other information such as testimonials 334, a member calendar 335 showing the member-specific events, reminders etc., a member compliance trend chart 336, and a member incentive tracker chart 337. It will also display the member intervention plan 338.

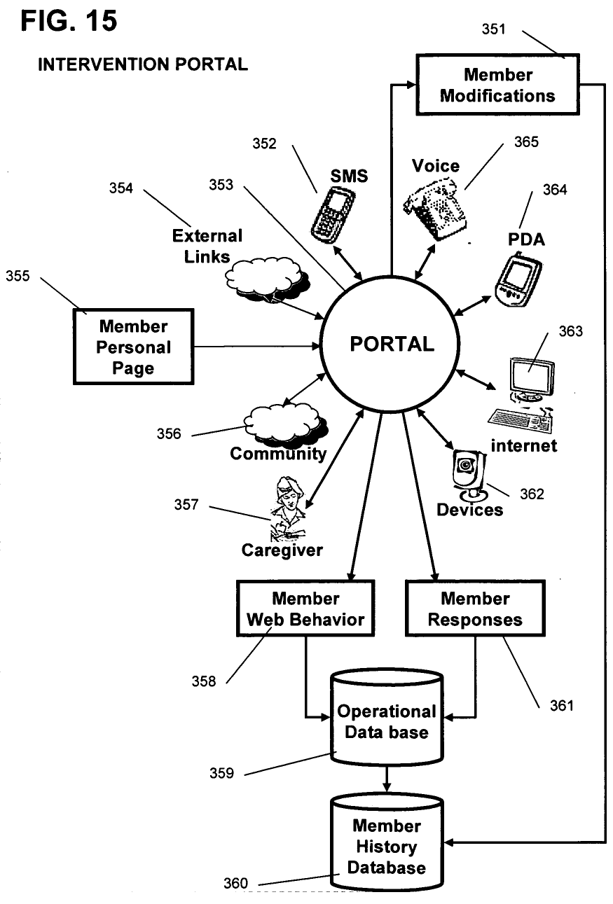

FIG. 15 shows an embodiment of the intervention portal and the elements that interact with the portal. The portal 353 provides access to members with an internet terminal 363 for initial enrollment, registration and data entry. Once member data has been entered, the system generates a personal page 355. A member, accesses the portal using an internet terminal, views his/her personal page and makes modifications 351 to interventions or links, which are then recorded in the member history database. Once the modified personal page is accepted, interventions begin per the member's personal plan. Interventions may be served by the portal through multiple channels such as SMS 352, caregivers 357, devices 362, internet (email) 363, PDA's 364, or voice 365. The portal also serves as the conduit for online communities 356 and external links 354. Measurements may also be received via the channels shown with double-headed arrows linked to the portal and these measurements in the form of member web behavior 358 and member responses to interventions 361 are recorded in the operational database 359, and later stored in the member history database 360.

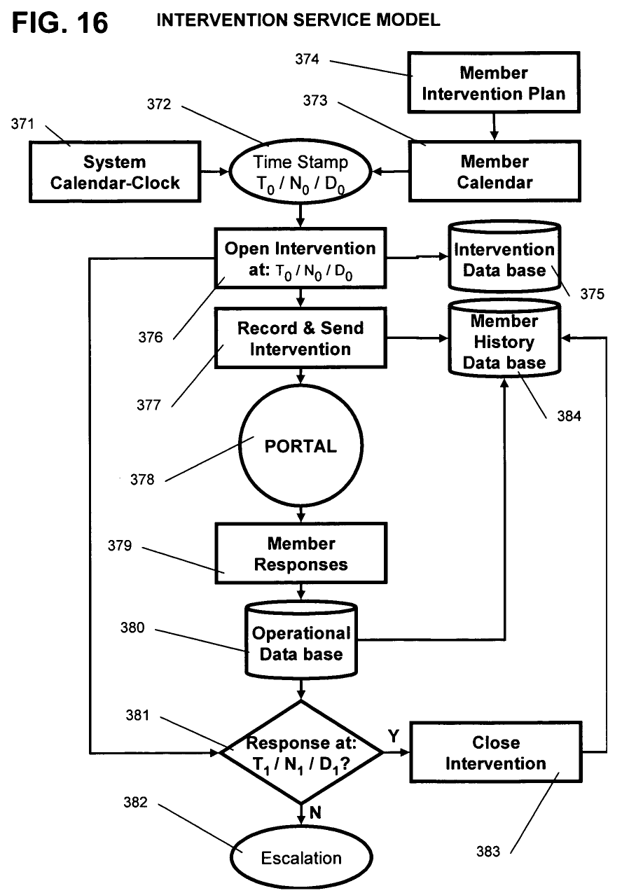

FIG. 16 is a flow chart of one embodiment of the intervention service model. The member intervention plan 374 makes intervention entries into the member calendar 373 that identify specific interventions, their timing and other parameters. The ‘Time Stamp’ algorithm 372, based on the system calendar-clock 371 and the member calendar, determines the appointed time T₀ for a particular intervention and passes the command to the ‘Open Intervention’ algorithm 376 that opens the particular intervention that is drawn from the intervention database 375. If the intervention is time-based, the algorithm records the time T₀; if the intervention is count-based, it records the zero count N₀; if the intervention is based on number of elapsed days, then the day count is zero'd. i.e. D₀. The ‘Record & Send’ algorithm stores the intervention record in the member history database 384 and the portal 378 then sends the intervention to the member. Member responses 379 are received and recorded in the operational database 380. The ‘Open Intervention’ algorithm continues to monitor the elapsed time, count or days as applicable to the intervention. At the appointed time T₁, the system checks the operational database to see if there has been a response to the intervention 381. Similarly if the appointed count is N₁ or appointed days are D₁. If there has been a response, the intervention is closed 383. If there has been no response, the system invokes the escalation process 382.

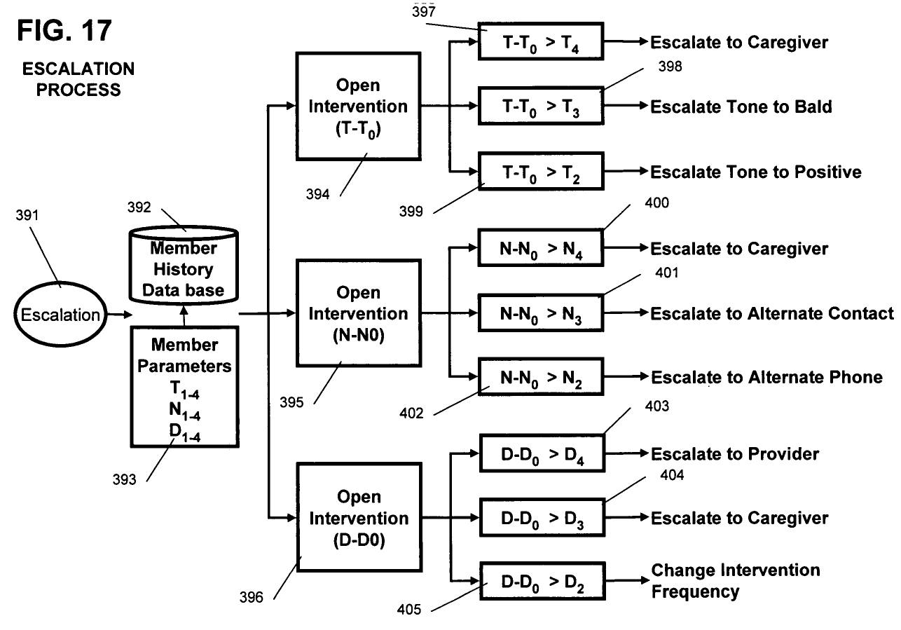

FIG. 17 describes one embodiment of the escalation process that begins 391 when there has been no response to an intervention at the first appointed time T₁, first appointed count N₁, or first appointed day D₁, depending on the type of the intervention. The appointed times T₁, T₂, T₃, T₄, appointed counts N₁, N₂, N₃, N₄, and appointed days D₁, D₂, D₃, D₄, are part of the set of member parameters 393 that are stored in the member history database 392. Once the system has passed control to the escalation process 391, a series of escalations 397 to 405 are implemented as described below. Three levels of escalation are shown for each type of intervention, to illustrate the process, but multiple and different numbers of escalations are possible for different intervention types. The ‘Open Intervention’ algorithm calculates the elapsed time (T−T₀) 394, elapsed count (N−N₀) 395 and elapsed Days (D−D₀) 396, depending on the type of intervention. For a time-based intervention, when the elapsed time has exceeded the member parameter T₂, the tone of the intervention is escalated to positive 399, then to a ‘bald’ tone 398 when it has exceeded the member parameter T₃, and finally, when it has exceeded the member parameter T₄, the caregiver is notified 397. As an example, a reminder intervention (time-based) may begin with a neutral ‘It is time for your morning medicine’ at T₀, then escalate the tone to a positive-polite ‘If you haven't taken your morning medicine already, please take it now’, then to a bald ‘Please take your morning medicine now’ (ref 9 Etiquette & Effectiveness: How Should a Smart Home Interact, Honeywell Laboratories, 2003). In a similar manner, for a count-based intervention, the number of times the intervention has been repeated (N−N₀) is tracked; at N₂, the intervention is sent to the alternate phone provided by the member 402, at N₃, the intervention is sent to the alternate contact (provided by the member, and could be an online mentor) 401, and at N₄, the caregiver is notified 400. Similarly, for day-based interventions, at D₂, D₃ and D₄ the escalation is to change the intervention frequency 405, notify the caregiver 404 and notify the provider 403, respectively.

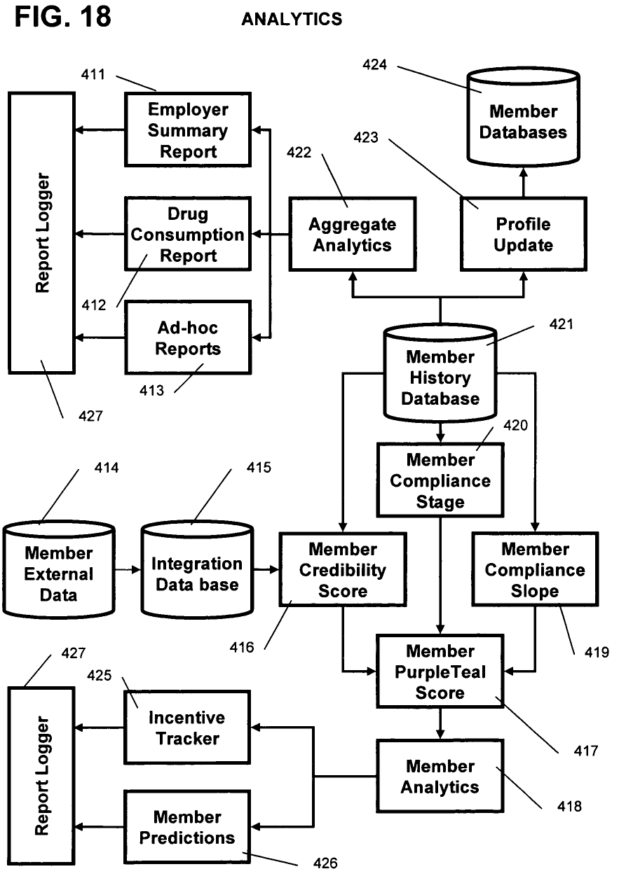

FIG. 18 shows the different analytics derived by the system. There are two major types of analytics—member analytics 418 and aggregate analytics 422. The member history database 421 is the main source of data for the aggregate analytics. Aggregate analytics are based on de-identified data about multiple members who may belong in a group, and may produce reports such as an employer summary 411 (summarized data about employees), drug consumption report 412 (estimating how many units of a drug have been consumed), or ad-hoc reports 413 as required by an authorized group representative. The member history database is also used for profile update analytics 423, which then update the member databases 424 to reflect new or changed profile information. As mentioned above, the member history database drives individual member analytics such as member compliance stage 420, member compliance slope 419. Further, using member external data 414 that has been stored in the integration database 415 in conjunction with the member history database, the system calculates the member credibility score 416. The member PurpleTeal score 417 is a combination of the member compliance score, compliance stage and member credibility score. The member PurpleTeal score drives the member analytics 418. Some examples, such as the incentive tracker 425 and member predictions 426 are shown. All analytics are recorded in the report logger 427.

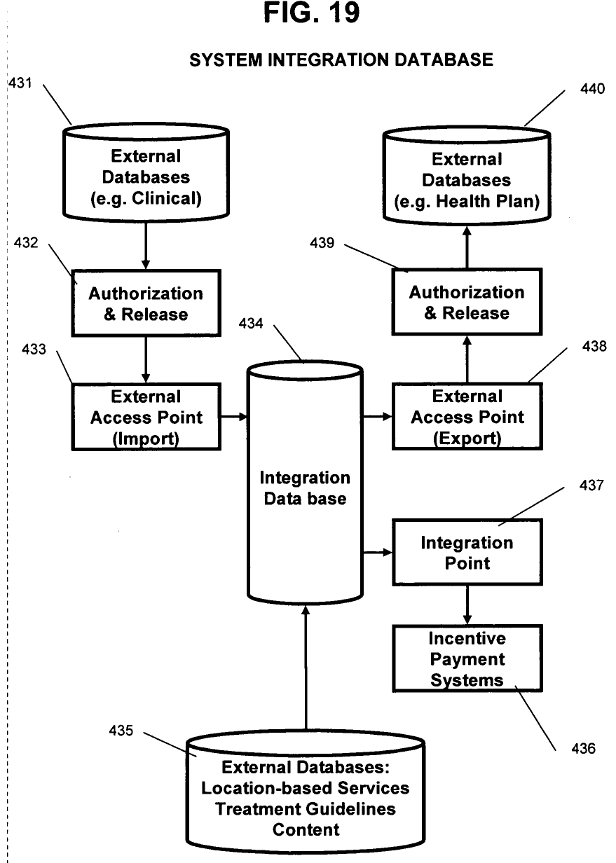

FIG. 19 describes the system integration database 434. This database serves as the staging area for data being imported or exported for purposes of integration between systems. Clinical and other member data from external databases 432 are imported through an external access point 433, but only after clearance from the authorization & release module 432. Data housed on public external databases 435 are directly imported into the integration database after the usual anti-virus and other integrity checks. Another integration point 437 transmits de-identified member-specific data to incentive payment systems 436 that may be operated by employers, who are not allowed to see individual member identifying information, by law. These incentive payment systems release the appropriate funds to specific members who meet the incentive requirements. Yet another external access point 438 is used for exporting data, subject to the required authorizations and releases 439, to external databases 440 that are operated by health plans and others who are authorized to view individual member information.

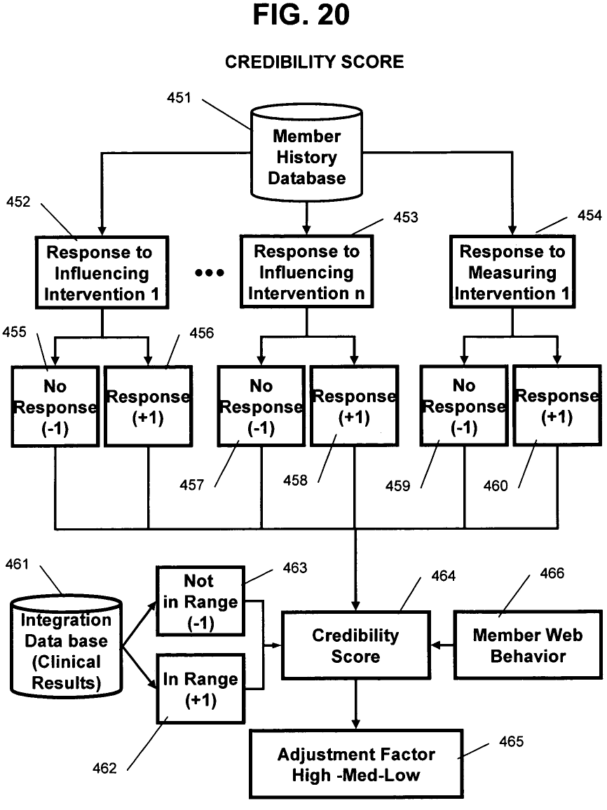

FIG. 20 describes the process by which the credibility score is derived. This is done on a continuous basis, being triggered whenever new information is recorded in the member history database 451. The credibility score is used to adjust the self-reported compliance information to compensate for the known over-estimation bias in self-reports. One determinant of the credibility score is the level of member engagement, as indicated by the number of member responses to interventions. The source of data for this process is the member history database 451, from which the responses to interventions 452, 453, 454 are evaluated. If there is no response, the item score is a −1, and if there is a response, the item score is a +1. The number of non-responses 455, 457, 459 and the number of responses 456, 458, 460 are summed to provide one component of the credibility score 464. Another component of the credibility score comes from the member web behavior 466, which also indicates the level of the member's engagement with the system at a user-interface level. The more engaged the member, in terms of clicking on the links provided, participating in online communities, and so on, the higher this component of the credibility score. A third component of the credibility score comes from the member's clinical information which typically resides in external databases held by providers and physicians and is imported into the integration database 461, assuming the required permissions and access rights are in place. The specific clinical data of interest are the key indicators of disease control, such as serum cholesterol levels, glycosylated hemoglobin for diabetics, and so on. Regardless of the member's compliance self-reports, the true test is whether the desired health outcomes are achieved. If a member's diseases are being controlled, the relevant disease indicators should be within normal ranges. If these indicators are not within normal ranges 463, the item score is a −1, and if they are within normal ranges 462, the item score is a +1. The item scores are summed and incorporated into the credibility score. The underlying assumption is that higher compliance, if self-reported by the member, should be reflected in the clinical results that are closer to normal values. There are situations where a particular drug, even if taken exactly as directed, may not produce the desired clinical results; these are treated as exceptions. The credibility score determines an adjustment factor 465, which is qualitatively set at high, medium or low, and the adjustment factor is used to reduce the self-reported compliance responses by 0, 25 or 50 percent, as an example. These are system parameters that can be set externally.

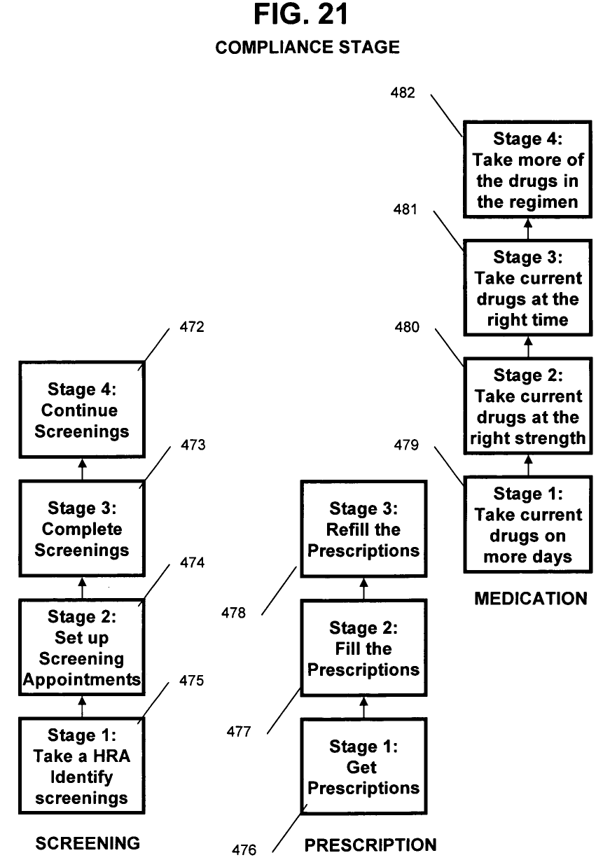

FIG. 21 shows the different stages of compliance. Compliance does not usually occur in one big step, going from a stage of poor compliance to full compliance, but proceeds in stages. For screenings, a member's Stage 1 475 would be simply to take a Health Risk Assessment (HRA) that would, among other things, indicate which screenings the member should go in for. Following that, one objective of this invention is to influence and enable the member to proceed onward to Stage 2 474 and actually set up the screening appointments, complete the screenings in Stage 3 473, and continue periodic screenings per clinical guidelines in Stage 4 472. For prescriptions, in Stage 1 476 the member needs to get the required drugs prescribed by the doctor or nurse, in Stage 2 477 the member has to fill the prescriptions, and in Stage 3 478 the member has to continue to refill the prescriptions. Once the prescriptions have been filled or refilled, the member proceeds to the consumption part of medication compliance. In Stage 1 479 the member takes whatever drugs he/she is currently taking, but on more days, in order to improve compliance in this dimension. Once the member has become habituated to taking the drugs on a regular basis, the focus moves to the dosage strengths. In Stage 2 480 the member is enabled and measured to take the drugs at the right dosage strengths. In Stage 3 481 the member is enabled and measured to take the drugs at the right time. Finally, in Stage 4 482 the member is influenced to take more of the drugs in their regimens. Eventually the member takes all of the drugs prescribed, not just a subset, takes the drugs at the right time, at the right dosage strengths and on all days as prescribed.

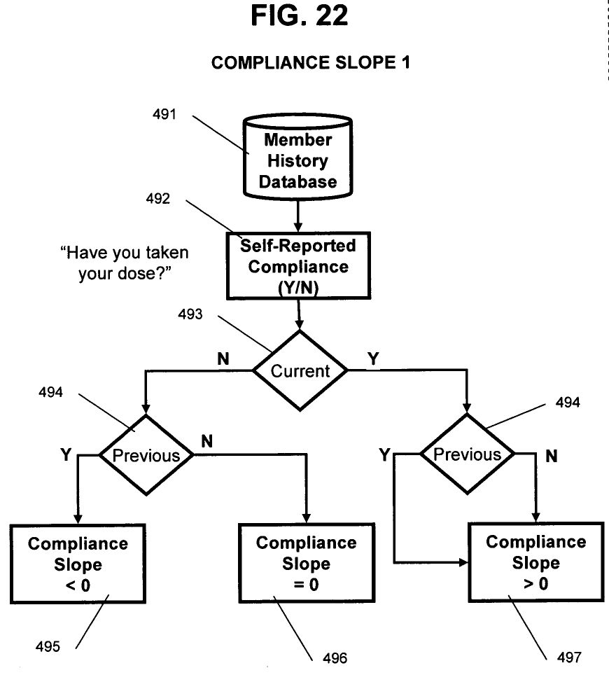

FIG. 22 describes a simple method by which the compliance slope is derived from one set of measurements that are responses to a question such as ‘Have you taken your dose?’that requires a ‘Yes or No’ or ‘1 or 0’ answer. The member history database 491 contains the historical responses to this measurement, including the current value 493 and the previous value 494. If the current value is a ‘No’ and the previous value is a ‘Yes’, the compliance slope 495 is deemed to be less than zero. If the current value is a ‘No’ and the previous value is also a ‘No’, the compliance slope 496 is deemed to be zero. If the current value is a ‘Yes’ and the previous value is either a ‘Yes’ or a ‘No’, the compliance slope 497 is deemed to be greater than zero.

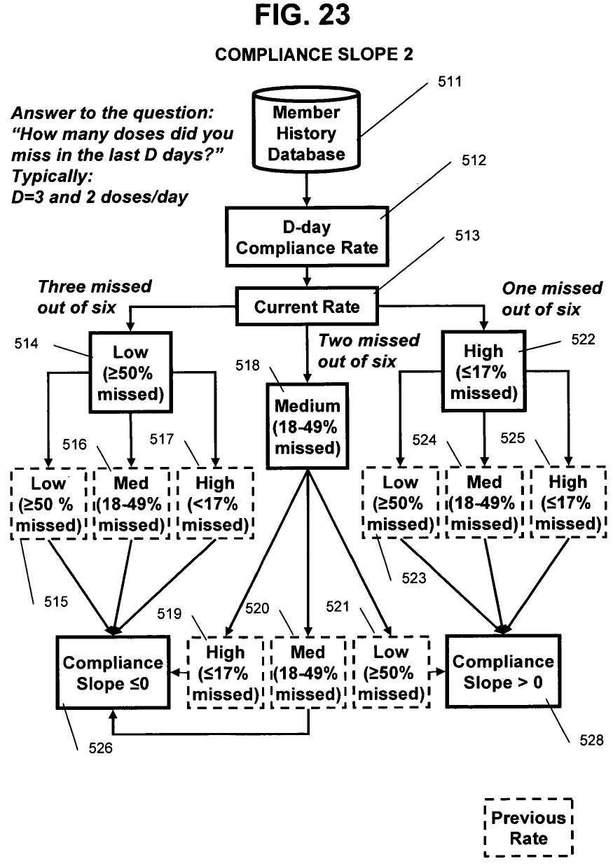

FIG. 23 describes the method by which the compliance slope is derived from a different set of measurements, namely, a question such as ‘How many doses did you miss in the last D days?’that requires a numeric response, typically 0 to 9. The response is converted to an D-day compliance rate 512. The member history database 511 contains the historical responses to this measurement and the calculated compliance rates. The rate is considered to be low if more than 50 percent of the doses are missed (typically three out of six doses in a 3-day period), medium if between 18 percent and 49 percent of the doses are missed (typically two out of six doses in a 3-day period), and high if only 17 percent or less of the doses are missed (typically one or none of the six doses in a 3-day period). If the current rate is low 514 and the previous rate is low 515, medium 516 or high 517, the compliance slope 526 is deemed to be less than or equal to zero. If the current rate is medium 518 and the previous rate is high 519 or medium 520, the compliance slope is also deemed to be less than or equal to zero. If the current rate is medium 518 and the previous rate is low 521, the compliance slope 528 is deemed to be greater than zero. If the current rate is high 522 and the previous rate is low 523, medium 524 or high 525, the compliance slope is deemed to be greater than zero. In this figure the previous compliance rates are shown in dotted boxes.

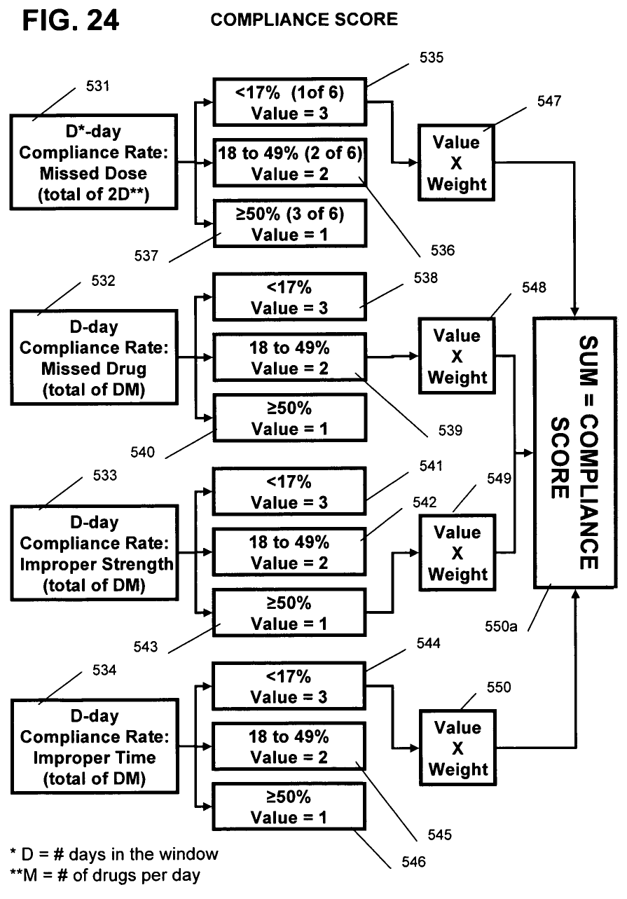

FIG. 24 describes one embodiment of the Compliance score calculation method. The compliance score 549 is calculated on a periodic basis, or when triggered by a measurement of the D-day compliance rate, in terms of missed dose 531, missed drug 532, improper strength 533, or improper time 534. The missed dose compliance rate is measured in terms of how many doses were missed out of the 2×D doses in a period of D days, assuming two doses per day, which is typical. This can easily be adjusted for members who have to take drugs once a day or more than twice a day by setting the member parameters accordingly. For the missed dose compliance rate, a value 535 of 3 is assigned if the rate is less than 17 percent, or less than one dose missed in the three-day period. Likewise, a value 536 of 2 is assigned to compliance rates between 18 and 49 percent, and a value 537 of 1 to compliance rates greater than or equal to 50 percent. Depending on the member's current compliance rate, the appropriate value is chosen, either 1, 2 or 3, as stated above. The value is then multiplied by a weight 547 and the result becomes one of the components of the compliance score 550a. Similarly, the missed drug compliance rate is also assigned values 538, 539, 540 of 3, 2 and 1, representing the rates of less than 17 percent, between 18 and 49 percent, and greater than or equal to 50 percent, respectively. In the same manner as with the missed dose compliance rate, depending on the member's current compliance rate, the appropriate value, 1, 2 or 3 is chosen, the value is multiplied by the respective weight 548 and the result becomes another component of the compliance score. The same method is used to calculate the other two components of the compliance score, namely improper strength compliance rate 533 and improper time compliance rate 534.

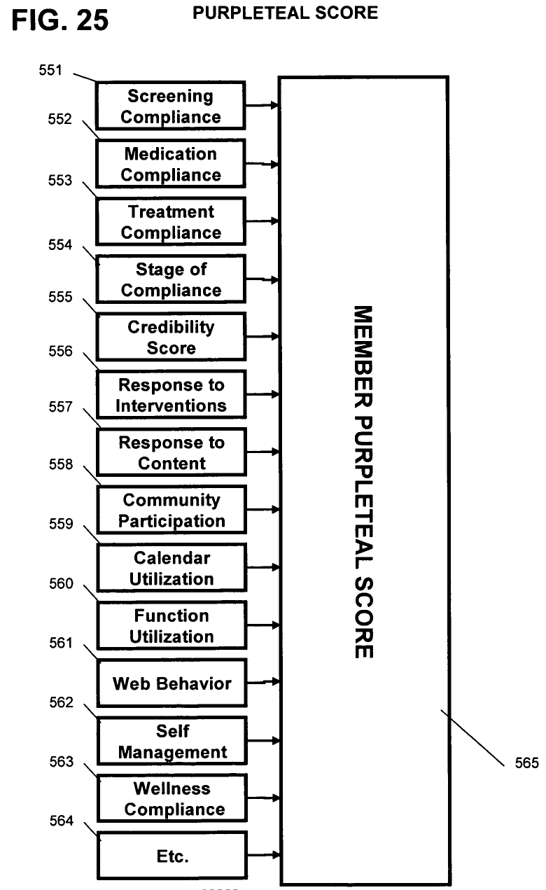

FIG. 25 shows the inputs to the Member PurpleTeal Score 565. The PurpleTeal score is a figure of merit that characterizes a member's overall health behavior, similar to a person's credit-rating. It is a combination of several scores: screening compliance 551, medication compliance 552, treatment compliance 553, credibility 555 and wellness compliance 563, and indicators: stage of compliance 554, response to interventions 556, response to content 557, community participation 558, calendar utilization 559, function utilization 560, web behavior 561, self management 562, and other indicators included in ‘Etc.’ 564. The scores and indicators for a particular member are combined to result in a single alphanumeric rating to yield the member's PurpleTeal score.

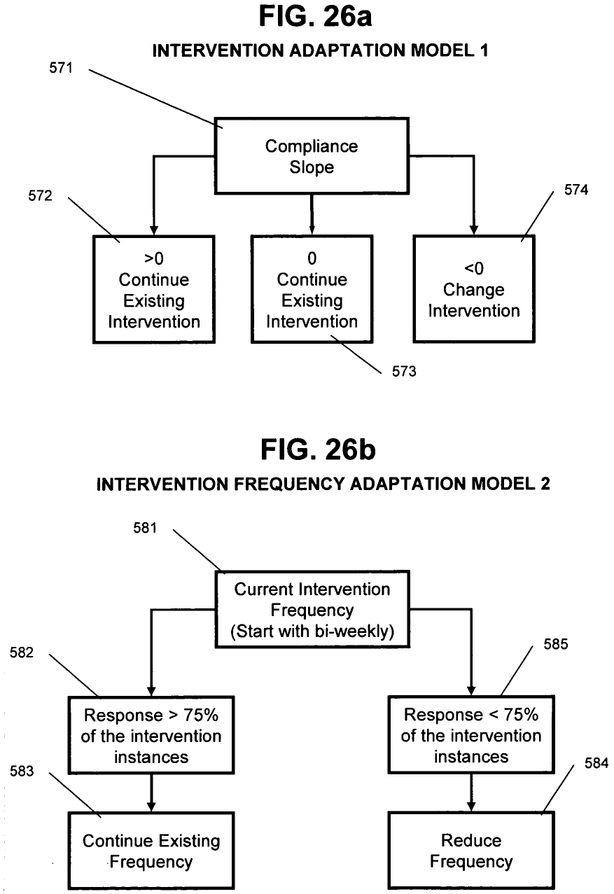

FIG. 26a describes one embodiment of the intervention adaptation model. In this embodiment, the underlying premise is if an intervention is working, it should be continued and interventions that have stopped working should be changed. The decision may be driven by the compliance slope 571, as shown in this figure, but other indicators such as the trend in compliance slope may also drive the decision. If the slope is greater than zero 572, or zero 573, the intervention is working and will not be changed. If the slope is less than zero 574, the intervention is not working and will be replaced or changed in some way.

FIG. 26b describes one embodiment of the intervention frequency adaptation model. In this embodiment, the underlying premise is that if a member does not respond to interventions (such as compliance measurements) every time, then the interventions are too frequent and should be made less frequent. There are other reasons for not responding, but in this embodiment, non-response is the criterion. Interventions are initially served at the current frequency 581, typically bi-weekly. If the member responds to instances of an intervention more than 75 percent of the time 582, the frequency is deemed to be matched to the member's preferences and the intervention frequency is continued 583. If the member response is less than 75 percent of the time, the intervention frequency is reduced 584.

### COMPLIANCE MANAGEMENT SYSTEM

The techniques described herein seek to improve an individual's health and thereby reduce the individual's utilization of expensive health care services, by providing personalized health interventions that not only influence and enable an individual to maintain a high medical compliance, but also observe the member's behavior, measure the individual's compliance and use this information to adapt the interventions as the member's needs change.

Medical compliance consists of the following: (1) wellness compliance, or actively participating in programs designed to keep people healthy (diet, exercise, weight management, stress management, smoking cessation, etc.), (2) screening compliance: getting screened for certain diseases based on age, gender, race and other risk factors as per medical guidelines, (3) medication compliance, or filling/refilling and consuming medications as prescribed, also known as ‘patient compliance’, and (4) treatment compliance, or going for specific condition-based treatments as prescribed. These and related terms are described below.

### Compliance Events

Opportunities for compliance occur at certain events. An individual's goes through several age-based stages such as pediatric, adolescent, dependent adult, adult, and geriatric. During a lifetime, many medical encounters and events may take place. Events include going in for health screenings, doctor visits, filling prescriptions, taking medication, etc., as shown in FIG. 7.

Events have a common structure and flow: targeting a specific event, commitment to the event, preparatory activity, event participation and follow up. In the case of a doctor appointment, the individual targets the physician, purpose and time of the appointment, then sets up the specific appointment (commits). If the appointment includes a lab test that requires the patient to be fasting, then starting at the recommended interval before the appointment event, the patient fasts (preparatory activity). Next comes the actual clinical encounter, or targeted event, i.e., the doctor appointment, at which the lab test may be reviewed, the patient examined and prescriptions for medications or referrals for further treatment may be given. After the appointment is the follow up period, during which the patient and doctor periodically conduct additional appointment to ensure the prescribed medications or treatments are working and the patient is cured, or in control of the disease.

### Wellness & Prevention Compliance

Wellness & prevention programs require individuals to engage in specific behaviors that reduce health risks these activities include health risk assessments, screenings and tests for specific diseases like hypertension or diabetes, immunizations, exercise, diet control, weight management, stress management, smoking cessation, etc. Many of the above are subsidized by employers, and some even offer incentives for enrollment or participation. In spite of the incentives, the actual rate of participation, in terms of how many individuals participate or how intensely they participate or how long they maintain the participation, is poor. A significant fraction of the population is unaware of the chronic illnesses lurking in their bodies; the CDC (ref 7 CDC unscreened stats) estimates that almost 32 percent of those who have hypertension do not know that they have it, a full XXX percent has not been screened for diabetes, XXX percent have not had a Pap smear, xxx percent has not had a mammogram, and so on. Clearly, these statistics indicate a significant level of non-compliance to wellness and prevention programs. Each of the above activities contains compliance events that provide opportunities for improvement. For example, a local pharmacy may sponsor a free hypertension screening event, or an employer may sponsor a work-place cholesterol and diabetes screening event. However, many do not take advantage of these events for many reasons, both situational and behavioral.

### Medication Compliance

A critical part of managing disease is medication—taking the right medicines at the right time at the right strength, and taking all of the medications prescribed by the doctor. An individual with multiple chronic illnesses may be prescribed several medications to be taken at different time during the day, for the foreseeable future. These times of day represent medication compliance events—times when an individual is required to take certain medications as prescribed. Whether the individual actually took these medications, and at what time of day, is of great interest from a compliance point of view. Using data about medication compliance events, physicians would be able to verify that their patients were indeed following their prescriptions properly, insurance companies would be able to verify whether patients were adhering to their regimens and offer incentives to improve adherence (if needed), pharmacies would be able to automatically process and deliver refills based on actual consumption, and pharmaceuticals companies would obtain more reliable clinical trial data. FIG. 7 shows examples of medication compliance events: AM (morning) and PM (evening) medication times, and a member-defined Time of Day medication event.

### Treatment Compliance

Another critical part of managing disease is treatment—performing certain procedures on a regular basis to keep the disease from deteriorating and to catch emerging complications early, when they are cheaper and easier to treat. An individual with diabetes, for example, should ideally get an eye exam and a foot exam every year to evaluate whether the early signs of certain common complications are present so that appropriate medications can be prescribed or other treatments started. These recommended treatment points are ‘compliance events’. The clinical guidelines for such treatments are well known but poorly followed, again for situational and behavioral reasons.

### Doctor Appointment Compliance

Patients occasionally forget doctor appointments and this is an example of a compliance event that can easily be addressed using appointment reminders—phone calls from the provider to patients or caregivers the day before the appointment have been very successful in reducing the number of no-shows. In many cases, a doctor visit (office appointment) involves a lab evaluation and discussion, followed by prescriptions or treatment recommendations, or a referral. Many lab tests require the patient to prepare for the test before coming in. For example, cholesterol and glucose tests require that the patient be fasting for at least 8 hours. Other tests such as bladder ultrasound require the patient to drink a fair amount of water and not urinate before the test so the bladder will be in a distended state for the test. Failing to comply with these requirements will void the test results, so appointments are either rescheduled or the patient made to wait for the lab equipment to become available at a later time. A lot of inconvenience and false results can be avoided if patients comply with pre-visit requirements. A reminder to patients listing the specific requirements for the upcoming appointment would be an example of an intervention provided by this invention. For example, an automated call to the patient on the evening prior to an appointment to check cholesterol with a message to not eat anything after midnight would keep the patient from forgetting. A similar call in the morning reminding the patient to not eat breakfast would be another example of an intervention in this regard.

### SYSTEM INPUTS

The various inputs to the system are described below. The following are discussed for illustrative purposes and represent an embodiment of the present invention. Additional elements or changes to existing elements do not affect the nature of the system, and such modifications are expected. In this embodiment, these inputs (see FIG. 2) are entered by the member or by an authorized party on behalf of the member. After entry, the data are stored in secure member databases. After registration, there are six categories of inputs and a calendar: demographics, state of health, stage of change, health beliefs, self-efficacy and compliance factors. The calendar is a separate form for entry of events etc.

### Registration

This is the first step. Member accesses the registration page by either accessing the website or clicking on a link provided on their benefits management page.

Once the member accesses the web site there is a ‘new user’ link on the page. Clicking on the link will take them to the registration page. Registration page has 2 options—‘registration’ and ‘express registration’. Both ‘registration’ and ‘express registration’ does not ask for the Member's name. It only will ask for the member to choose a usemame and password. Hence the Usemame is ‘de-identified’ from the actual person's name. Before assigning the usemame and password the member is asked to sign the terms and conditions. Terms and conditions include the HIPPA release form and agree that all disclaimers have been understood. The member then gets the userid and password assigned. The member can now log in and start the session by entering the inputs. A Progress bar will show the progress of the input session, what percentage of the inputs has been filled, the position of the current page, and how much is left to complete the input session. The member can stop and save the session anytime. In addition the session is autosaved every few minutes. The member can hence stop anytime and resume by logging in again

### Demographics

Demographics questionnaire captures the member's demographical data. Demographical data includes age, gender, race, family size, family arrangements, caregiver access, education, language, religion, job, industry, work class, income, work schedule, travel schedule, commute, hobbies, disabilities/pain, insurance coverage, access to computer, access to phone, etc. The Age questionnaire has the following ranges:
<5
5-9
10-14
15-19
20-24
25-34
35-44
45-54
55-59
60-64
65-74
75-84
85+
   Similarly all the demographical questions has radio buttons that corresponds to ranges or values for each of the other demographical data.

### State of Health

The State of Health questionnaires capture several items regarding the member's health. Starting with the member's health interests in terms of disease information, treatment information and risk information, other questionnaires include the member's state of disease screening, participation in prevention and wellness programs, any disease symptoms, whether any disease have been diagnosed, and if so, have treatments been prescribed, and whether the diagnosed disease are under control. In addition, a health risk assessment may also be administered.

The disease questionnaire has the following items for which a check box is provided to indicate interest in the following diseases. These are shown for illustration only and the list may grow in other embodiments:
Arthritis
Asthma
Allergy
Sinus dis
Cancer
CVD (cardio vascular disease)
COPD (chronic obstructive pulmomnary disease)
Depression
Diabetes
Elevated cholesterol
Migraine
GERD (gastric esophageal reflux disease)
Hypertension
Hormonal dis
Kidney dis
Ulcer
Other
None
Colorectal cancer
Breast cancer
Cervical cancer
Prostrate cancer

The screening questionnaire has a series of items relating to specific disease that should be screened for per medical guidelines, and have multiple checkboxes to indicate the proper response. An example is given below:

My blood pressure was measured by a health professional:

[ ] never measured [ ] 1 year ago [ ] 2 yrs ago [ ] 3 yrs ago [] 4 yrs ago [ ] over 5 yrs ago
   I was tested for colorectal cancer (sigmoidoscopy or colonoscopy) by a health professional:
[ ] never measured [ ] 1 year ago [ ] 2 yrs ago [ ] 3 yrs ago [ ] 4 yrs ago [ ] over 5 yrs ago
   I was tested for breast cancer (Mammogram) by a health professional:
[ ] never measured [ ] 1 year ago [ ] 2 yrs ago [ ] 3 yrs ago [ ] 4 yrs ago [ ] over 5 yrs ago
   I was tested for cervical cancer (PAP smear) by a health professional:
[ ] never measured [ ] 1 year ago [ ] 2 yrs ago [ ] 3 yrs ago [ ] 4 yrs ago [ ] over 5 yrs ago
   I was tested for prostate cancer (PSA) by a health professional:
[ ] never measured [ ] 1 year ago [ ] 2 yrs ago [ ] 3 yrs ago [ ] 4 yrs ago [ ] over 5 yrs ago

For Prevention state of health, an example is as follows:

Weight-loss program—I am: [ ] not enrolled [ ] enrolled [ ] active [ ] achieving results

Exercise program—I am: [ ] not enrolled [ ] enrolled [ ] active [ ] achieving results

Smoking Cessation program—I am: [ ] non-smoker [] not enrolled [ ] enrolled [ ] active [ ] achieving results

Vitamins—I am: [ ] not taking [ ]taking

Alcohol—I consume: [ ] none or occasionally [ ] 1-5 drinks a week [ ] 6-14 drinks a week [ ]

In the ‘Disease Symptom’ state of health questionnaire, only those diseases that the member has indicated to be of interest in the ‘Disease’ questionnaire above, are shown to the member, although the complete list consists of all the diseases listed. An example of the questionnaire for each shown disease is given below:

I have (for disease):

[ ] None or Hidden Symptoms
[ ] Overt or Visible Symptoms
[ ] Mild Symptoms
[ ] Moderate Symptoms
[ ] Severe Symptoms
[ ] Impairments
[ ] Complications

In the ‘Diagnosis’ questionnaire, again, only the diseases selected by the member are shown, and for each shown disease the following questionnaire is displayed:

I have (for disease):

[ ] Early signs
[ ] Diagnosed less than 1 year ago
[ ] Diagnosed more than 1 year ago

In the ‘Treatment’ questionnaire, only for the diseases that have been diagnosed, the following questionnaire is displayed:

For (disease) I am:

[ ] not taking treatment
[ ] medications prescribed
[ ] medications being taken as prescribed most of the time
[ ] medications being taken but not exactly as prescribed
[ ] treatments prescribed
[ ] treatments being taken

In the ‘Control’ questionnaire, again, only for the diseases that have been diagnosed, the following questionnaire is displayed:

For (disease)

[ ] not under control
[ ] under control less than 1 year
[ ] under control less than 5 years
[ ] under control more than 5 years

### Stage of Change

Long-term studies of behavioral change, coming from the field of addiction treatment, show that lasting behavioral change comes only when the patient is motivated to change. Externally imposed cues to change behavior only work as long as they exist; as soon as the cues are removed, the behavior quickly reverts. In this regard, the pioneering works of Prochaska and DiClemente (ref 10 Prochaska & DiClemente Stage of Change) are crucial in setting the stage for compliance-related behavioral change—they found that people who have successfully changed their behavior in the face of barriers and challenges go through the same five stages of change: (1) pre-contemplation, in which even the thought about changing behavior does not occur, (2) contemplation, in which the person starts to think about changing their behavior, (3) decision, in which the person makes a decision to change their behavior, (4) action, in which the person takes specific actions towards changed behavior, and (5) maintenance, in which the actions are sustained over time, in the face of life-events that would normally have driven the person to the previous behavior. This is not a perfect straight-line model, so in the maintenance stage, ‘relapses’ do occur, and the person may go through all or some of the other stages repeatedly, but over time, will adhere more to the new behavior than to the old. In the present invention, these concepts are applied to the field of medical compliance. Taking a young individual who is not even thinking about disease risks to the point of seeking the recommended screenings, for example diabetes screenings, requires consistent, highly targeted (i.e., personalized) interventions. Such an individual is in the ‘pre-contemplation’ stage and first needs to be influenced to start thinking about disease risks, i.e., to move to the ‘contemplation’ stage. Thus the present invention may provide interventions highlighting the potential consequences of neglecting certain diseases—an example would be a testimonial from person similar in age, gender, race socioeconomic status etc. (i.e., as close to the individual's profile as possible), showing the effect of not going in for a diabetes screening such as blindness. Multiple interventions, repeated periodically, with different content, but conveying the same message (‘you need to go in for a diabetes screening’) are necessary. The frequency of the interventions is also important—daily interventions would probably cause the individual to consider them a nuisance and ‘tune them out’, whereas monthly interventions would probably not register in the individual's memory and would therefore not be effective either. The present invention derives the initial frequency from the individual's profile and automatically adjusts the frequency based on the response or non-response from the individual, thus increasing the chances of getting the message through, and moving the individual to the ‘contemplation’ stage. Once in the contemplation stage, the individual needs different types of interventions—‘enabling’ rather than ‘influencing’, to help decision-making and move the individual to the next stage, namely, ‘decision’. In the action and maintenance stages, the individual requires yet other types of interventions, both enabling (such as reminders) and measuring (to ascertain the level of compliance). As the individual moves from stage to stage, forwards or backwards, the present invention adapts and provides the required types of interventions to keep the individual engaged in their health and moving towards self-efficacy, or the ‘maintenance’ stage.

The inputs for the stage of change are in the form of a questionnaire with either ‘yes/no’ or a scaled response option. The questionnaire is adapted from www.nzgg.org.nz/guidelines/0040/Appendix_{—}3_change.pdf to reflect medication compliance. The exact form, number of items and scoring method may vary as more is learned, but in one embodiment, the stage of change questionnaire may be as follows, with a five-point scaled response option indicating strong agreement, agreement, neutral, disagreement or strong disagreement to the items:
(1) I am OK with how I take my medications
(2) I am trying to take my medications more regularly than I used to
(3) I sometimes miss taking my medications
(4) I should cut down on the times I miss taking my medications
(5) It's a waste of time thinking about missing my medications
(6) I have just recently changed my habits of taking medications
(7) Anyone can talk about taking medications regularly, but I am actually doing something about it
(8) I am at the stage where I should think about taking my medications regularly
(9) I have a problem with taking my medications
(10) It's alright for me to keep taking my medications as I do now
(11) I am actually changing my medication taking habits right now
(12) My life would still be the same, even if I missed fewer of my medications
   The scoring method is to add up the points corresponding to the items that represent the different stages of change and place the individual in the stage with the highest score.

### Health Beliefs

Health beliefs determine the specific actions of the individual. As described above, in order to get an individual to even think (or contemplate) health risks, initial interventions are oriented towards raising awareness of the individual's ‘perceived susceptibility’ to certain diseases. Sometimes this is not enough and the interventions have to be raised to another level in order to raise the individual's ‘perceived severity’ if the diseases are allowed to take root, such as horror stories. These interventions, repeated at the right frequency, will eventually cause the individual to think about doing something, but typically all sorts of ‘perceived barriers’, real and imagined, come up. At this point, the individual needs ‘enabling’ interventions that highlight ways in which the barriers can be overcome, testimonials about how others have overcome similar barriers, links to online communities where questions can be asked with anonymity, link to an online anonymous mentor who can guide the individual and so on. Interventions highlighting the benefits of taking action, such as testimonials can also ‘influence’ the individual into taking action. The individual may also need, based on perceived self-efficacy, ‘cues to action’ that exploit existing habits of the individual to improve compliance, for example, linking the already established habit of brushing teeth at night to taking the evening dose. In addition, the individual's trust plays a key part in compliance. If there is adequate trust in the healthcare system, the doctor or the pharmacist—that they are indeed looking out for the individual, the chances of compliance are higher. If the individual's trust in medications or treatments is poor, the chances of high compliance are also poor. Therefore, one goal of the present invention is to provide interventions geared towards increasing the overall health beliefs of the individual.

The inputs are in the form of questionnaires with either a ‘Yes/No’ or a scaled response option and cover the following dimensions: trust in the healthcare system, trust in the physician, trust in the pharmacist, trust in medications and treatments, perceived susceptibility, perceived severity, perceived barriers, perceived benefits and cues to action. The exact form, number of items and scoring method may vary as more is learned, but in one embodiment, the health-belief questionnaires may be as follows, with five-point scaled response options indicating strong agreement, agreement, neutral, disagreement or strong disagreement to the items presented. The <disease>indicates a variable such that the specific name of a disease may be specified for a particular individual.

A. Perceived Susceptibility:

(1) People like me do not get <disease>.
(2) I would rate my chances of getting <disease>as poor.
(3) Whenever I hear of someone getting <disease>, it makes me realize that I could also get it.
(4) I think about the possibility of getting <disease>some day
(5) 1 am at risk for getting <disease>
   B. Perceived Severity:
(1) <disease>can be serious if I get it
(2) <disease>will affect my job
(3) <disease>will affect my personal life
(4) <disease>will limit my activities
(5) <disease>could make me disabled
   C. Barriers:
(1) I would have to change many habits to follow my diet, exercise or medication regimen.
(2) It will be difficult to follow the diet, treatments or medication regimens prescribed for me.
(3) I cannot understand or remember what I've been told about my diet, treatments or medications.
(4) Exercising, watching my diet, and/or taking my medications interferes with my normal daily activities.
(5) Knowing about all my health conditions makes life miserable
   D. Benefits:
(1) Improving my diet and exercise habits will make me feel better.
(2) Going in for health screenings every year will catch any diseases early
(3) Taking my medications regularly will keep my <disease>from getting worse.
(4) Good diet, exercise and medication habits will maintain my health
   E. Cues to Action:
(1) I follow the same routine every day when I get up
(2) I make notes to myself to take my medications during the day
(3) I have things to help me remember to take my medications at the appropriate time
(4) Someone usually has to remind me to take my medications

### Self Efficacy

Self-efficacy is a measure of the confidence and independence of the individual. An individual with high self-efficacy can be expected to find out what to do and actually do them, whereas someone with a low self-efficacy needs help. An individual with high self-efficacy is likely to be high in compliance as well, and vice versa. Self-efficacy applies to multiple areas of health, and an individual's self-efficacy can be different in each area. For example, someone who is completely self-efficacious in taking medications can be totally not so in the area of smoking-cessation.

The inputs to self-efficacy are in the form of short questionnaires indicating levels of self efficacy in each of the areas of: screening, diet, exercise, stress, smoking cessation, medication and treatment. In one embodiment, the screening self-efficacy questionnaire may be as follows:
[ ] I can figure out what to do and do it myself
[ ] I need some help to figure out what to do
[ ] I need someone to figure it out for me
[ ] I need someone to make sure I <perform the action>(such as go for screenings, follow my diet, exercise regularly, manage stress levels, stop smoking, take medication and go for treatments.

### Medication Compliance Factors

Medication compliance, as mentioned previously, is taking all the prescribed medications as directed, at the right time and at the right dosage strength. This turns out to be quite difficult for many individuals. Studies show that overall compliance is only around 50 percent. In this embodiment, we characterize the individual in terms of several factors that influence compliance, namely regimen complexity, unpredictability of life/work, forgetfulness, cost, drug efficacy, access to medications, knowledge about medications, knowledge about clinical results, side effects, secrecy, denial and confidence factors.

A complex regimen with multiple pills and capsules to be taken at different times on a daily basis (such as regimens for those with HIV or multiple chronic illnesses) can be challenging and individuals frequently miss a drug or two, or forget that they have already taken them and take them again (resulting in potentially dangerous overdosing), or simply give up and stop taking them.

Unpredictability of life/work frequently prevents individuals from taking their medications at the proper times of day. If they are in meetings or otherwise occupied, they might not be able to take the dose at the right time, but may have to wait for an opportunity to take them.

Forgetfulness is one of the main reasons for non-compliance, according to a study by the Boston Consulting Group (ref 3). In the course of their busy lives, people frequently forget to take their medicines or to pack them before going on a trip.

Cost is another dominant reason for non-compliance. People are usually required to pay some amount of money in the form of co-pays or co-insurance, depending on their health plan. If the co-pays are high, people sometimes skip the drug. This behavior is also a function of socio-economic and insurance coverage status, with poorer or uninsured people more likely to skip the drug.

Drug efficacy has to do with whether the individual continues to take the prescribed drugs even if symptoms are not present in the belief that the drugs are working to control disease. It is quite common to see people stopping their medications as soon as they feel better, especially in the case of antibiotics. Some diseases do not present overt symptoms such as hypertension, yet wreak havoc within the body, and the effects only become apparent when a catastrophic cardiac event occurs.

Knowledge about medications—when people understand how the medications work to control disease, they are more likely to take their medications as directed.

Knowledge about clinical results—when people know what the clinical results (lab tests) represent, whether they have the disease under control or not, they are more likely to take the medications as directed. When they know the results are abnormal, they will tend to take their medications more regularly.

Side effects are a big reason for non-compliance. Even if an individual realizes that a medication is necessary to control a disease, side effects can be bad enough to inhibit regular consumption. When the cure is worse than the disease, poor compliance is often the result.

Secrecy is another reason why people miss taking their medications. Not wanting anyone to know that they are taking medications, is a big concern especially in the work environment where it may be seen as a weakness. Others simply want to maintain privacy.

Denial of disease is quite common and people will resist taking medications since taking them would be an admission that they have a disease.

Confidence is a leading indicator of compliance behavior. It is a measure of the level of confidence of the individual in taking the medications as prescribed, in the face of common barriers. In providing the inputs for this dimension, the individual actually programs himself or herself for high compliance.

### Calendar

The compliance calendar is a key element of the member's interaction with the system, both in terms of inputs and outputs. In terms of inputs, the calendar is used to directly enter events related to the member, dependents or pets (appointments, etc.). Certain scheduled compliance events, reminders, screening events, and so on can be pre-populated on the member's calendar by importing relevant event data from external databases.

### Pre-population of fields

If member data exists in the employer, health plan or other database, they can be imported and the input data entry fields can be pre-populated. Members only need to verify or correct pre-populated data and add missing data, thus simplifying the data input.

### PERSONALIZATION

A key aspect of this invention is the deep level of personalization that is provided by the system. Based on the member inputs, a multi-factor profile is developed and this profile drives the personalization of specific interventions. The inputs outlined above are loaded into the member database and a profile is developed in terms of member-specific factors (see FIG. 3). In one embodiment, the following factors are used: vulnerability, affordability, stress, comprehension, screening and treatment. In other embodiments, additional factors may be included or existing factors may be dropped. These factors are discussed for illustrative purposes only.

Vulnerability is an indicator of the diseases to which the individual may be susceptible, based on age, gender, race, job type and other factors. An individual's genetic endowment predisposes him or her to certain diseases, but environmental risk factors and lifestyle also play a key part. For example, if the member is of a certain age, gender and race combination that has a high prevalence of a disease, say, diabetes, then the member is deemed to be at high risk for diabetes and is therefore a candidate for screening. Screening for diabetes typically includes a fasting glucose and/or an oral glucose tolerance test—there are medical guidelines from organizations such as the AHRQ (Agency for Healthcare Research and Quality) that recommend screening tests for various diseases. Screening tests are sometimes covered by some health plans, making it easier for the member to get screened. The member's job title indicates whether it is an active or sedentary job, and if it is the latter, then the risks for diabetes are higher. The member's screening state of health indicates whether the member has already been screened for diabetes, and how many years ago. If the member has not been screened at all or for more than two years, then he/she needs to be influenced to do so. The member stage of change data may indicate that the member is in the pre-contemplation stage, so the influencers need to be oriented towards increasing awareness of the disease prevalence, increasing the perceived susceptibility to diabetes by virtue of age, gender and race, and increasing the perceived severity of the disease.

The vulnerability mapping algorithm uses ‘if-then-else’ type of logic to take these factors into account and identifies a set of candidate interventions of two types: mandatory and supplementary (see FIG. 11), from the interventions database. An example of a mandatory intervention in this case might be emails regarding a specific diabetes screening event at the workplace a week before and a day before the event respectively, an SMS reminder just prior to the event urging the member to go for the screening, and an SMS measurement a day after the screening to verify that the member went for the screening. Examples of supplementary interventions might be links to content on the member's PurpleTeal personal page about the dangers of neglecting diabetes, statistics about how many people neglect diabetes and horror stories about people who have neglected their diabetes and gotten into severe complications. These interventions are generated by the mapping algorithm and then consolidated into the mandatory and supplementary categories (see FIG. 12).

Affordability is an indicator of whether the member can pay for the screening, drug or procedure. In one embodiment, affordability is based on income, family size and insurance coverage (from the demographics inputs) and indicates whether the member is likely to go for the recommended screenings or take the prescribed drugs and treatments.

In a manner similar to the vulnerability mapping above, the affordability mapping algorithm uses ‘if-then-else’ type of logic to take these factors into account and identifies a set of candidate interventions of two types: mandatory and supplementary (see FIG. 11), from the interventions database. In the case where the member is not filling drug prescriptions because of cost, an example of a mandatory intervention might be emails suggesting programs that offer free drugs, an SMS message to remind the member to contact the free drug program and another SMS message to verify that the member has contacted the program. Some employers have waived co-pays for certain chronic disease medications, and in this case, the member should be made aware of this via an mandatory email. Supplementary interventions may include emails to ask the doctor for samples, ask for a higher dosage prescription and split the tablets (if feasible), manufacturer discount program links or links to coupons and so on. As with the vulnerability mapping, these interventions are also generated by the mapping algorithm and then consolidated into the mandatory and supplementary categories (see FIG. 12).

Stress, in one embodiment, is determined by the member's job, work schedule, daily commute, family size, family arrangements and state of health. Other factors may also be included on different embodiments. In a manner similar to that described above for vulnerability and affordability, the stress mapping algorithm generates a set of mandatory and a set of supplementary interventions, that are then consolidated as shown in FIG. 12.

Comprehension, Screening and Treatment are other mappings in this embodiment that generate respective sets of mandatory and supplementary interventions that are subsequently consolidated. These mappings are cited for illustrative purposes. In other embodiments, additional and different factors may be employed in different combinations to generate the same two sets of interventions: mandatory and supplementary, that are then consolidated.

### Intervention Plan Composition

Once all the mappings have been executed and the mandatory and supplementary interventions have been generated and consolidated, the member-specific intervention plan is composed (see FIG. 13). In one embodiment, the following methods may be used to further personalize the interventions. These methods are discussed for illustrative purposes and other methods may be used in other embodiments.

Weighting & ranking: member factors such as vulnerability, affordability, etc., are not all of the same importance, and may be different for different members. For example, a member with a serious illness may be more concerned about vulnerability than affordability, whereas a member with low income may be concerned more about affordability, even at the cost of neglecting his or her health. These factors need to be weighted differently depending on the member profile. The weighting and ranking algorithm first calculates member-specific weights for the different factors and then applies the weights to the interventions driven by the respective factors. If an intervention is repeated, each instance is weighted by the respective weight, and the total weighted counts are added to yield a weighted score for each intervention. The interventions are then ranked in the order of the weighted scores.

Disease criticality ranking: in this method, certain diseases are deemed more urgent and severe than others, for instance, asthma, some types of diabetes or heart-related diseases are potentially life-threatening and the effects can be severe, so they are high on the criticality list. Diseases that involve pain or similar debilitating symptoms but are not life-threatening, are deemed to be lower in criticality, and diseases that do not have overt symptoms or have slow-changing effects, such as cholesterol are lower on the criticality list. In this method, the interventions are arranged in the order of disease-criticality.

Filtering: as another step in the personalization, in this method, the interventions are filtered using the member profile and factors. If any interventions generated by the various algorithms are mismatched to the member profile, the chances of being ignored are higher. This method serves as a final filter to eliminate interventions that do not match the member's age, gender, race, socio-economic status, education level, etc. The objective is to ensure that only the most appropriate interventions are sent.

Categorization into disease-specific folders: as the final step in the personalization, the interventions are categorized into disease-specific categories and grouped together into separate ‘folders’ for display purposes. A consolidated view is also generated for display (see FIG. 13).

Initial frequency and timing—Each intervention has a frequency and timing when it is sent to the member. Depending on the intervention, the frequency is set at daily, twice weekly, weekly, monthly, quarterly or annually. For example, a medication reminder may be set at a daily frequency and the timing may be set at 8:00 AM and/or 8:00 PM. A compliance measurement reminder may be once a week, or may be sent on random days, at random (but reasonable) timings. Timing is also event driven, for example sending a medication packing reminder to a member on the evening before an out-of-town trip is based on the timing of the trip.

Personal Page, member modifications and acceptance: the member is shown a personal page (see FIG. 14) with different elements, including the consolidated and categorized folder views of the interventions planned for the member. From this page, the member can accept or modify the interventions, their timing and other parameters. Mandatory interventions cannot be deleted but their timing and frequency can be modified. Supplementary interventions can also be deleted by the member. Once the member has modified the personal intervention plan, he or she has to accept the plan in order to activate it, after which the interventions are automatically sent. The member can login to their personal page at any time and modify the interventions. Until acceptance, none of the modifications are valid.

### Intervention Database

As shown in FIG. 9, in one embodiment, the intervention database is a repository of all the interventions that can be sent by the present system. Links to third-party interventions are also stored here, to be drawn upon when appropriate, and the respective e-commerce interactions are enabled. The present system can thus be a single point of reference for all interventions to be sent to a particular member, whether the interventions are within the present system or within external parties. The interventions are structured into the intervention model below before storage in the database. This structure facilitates the identification of appropriate interventions from the database for a particular member.

### Intervention Model

With respect to FIG. 9, the attributes of an intervention constitute the intervention model. The attributes shown in this embodiment are for illustrative purposes and may be expanded in other embodiments.

Types of interventions: interventions may be of different types depending on the purpose. The types in one embodiment are: informational, influencing, enabling, measuring, and event-driven. Informational interventions convey information one-way to the member, such as event dates or appointments. Influencing interventions seek to increase awareness, increase perception of susceptibility, and so on, with the expectation of some thought or action from the member. It may be informational but the intent is to elicit some response, either overt or hidden. As mentioned previously, compelling images of people who have suffered as a result of neglecting their diseases may influence the member to start thinking about their own situation. Enabling interventions are designed to help the member carry out some task. For example, a member in the decision stage of change with respect to screenings may find an action item checklist useful in scheduling and attending screenings, i.e. moving to the action stage of change. Measuring interventions are designed to ascertain various compliance behaviors. For example, a member who has moved to the action stage of change with respect to screenings and has set up the screening appointments may be sent a measuring intervention after the screening to ascertain whether or not the member actually went for the screening. Interventions are also event-driven. An example might be a checklist of items to discuss with the doctor that is sent before an appointment.

Intervention Channel: interventions are transmitted through multiple channels such as: SMS (cell phone), email, landline, alternate (family member, caregiver, and neighbor) phone, pager, PDA, internet, online community, online mentor, doctor, provider, nurse, pharmacist, volunteer and so on. The purpose of the channel is to electronically or physically get the intervention to the member. Some channels are more effective than others, depending on the member's profile, and the present system automatically selects the most appropriate channels for the member. It is well known that multiple channels do a better job of conveying the message, so the same intervention may be sent over more than one channel.

Intervention frequency: each intervention has a frequency at which it is sent to the member. Depending on the intervention, the frequency is set at daily, twice weekly, weekly, monthly, quarterly or annually. For example, a medication reminder may be set at a daily frequency. A compliance measurement reminder may be once a week, or may be sent on random days. An annual checkup reminder may be sent once a year.

Intervention timing: interventions also need to be timed for maximum response from the member. Morning and evening medication reminders may be sent to one member at 8:00AM and 8:00 PM, and at different times for a different member. The timing can also be member-defined. In addition, if a member is traveling in different time zones, the reminder timings have to be automatically adjusted for the respective time zones. Timing is also event driven, for example sending a medication packing reminder to a member on the evening before an out-of-town trip is based on the timing of the trip. Other events include: before food, after food, before screening, after screening, before doctor visit, and so on (see FIG. 7).

### Content Database

As shown in FIG. 10, in one embodiment, the content database houses the raw information that is transmitted by an intervention. Content, in the form of test, graphics, photographs, audio, video, and other common formats are indexed and stored in the database. In some cases, external content may be imported and cached in the content database for quick, accurate and reliable access, especially for content from links that change over time. All content, regardless of source, is stored in the content database and standard content management methods are used to maintain the freshness of the content.

### Content Model

As shown in FIG. 10, in one embodiment, the content model characterizes each specific content item in terms of several elements: topic, disease, disease-state, stage of change, language, readability, demographic-appropriate, format and ranking. Individual content items are categorized in terms of these elements in order to facilitate selection for interventions. For example, a content item may be a highly rated (ranking) video (format) in English or Spanish (language) with subtitles (readability) of a young man (demographic-appropriate: age, gender) who has gone blind (disease-state) as a result of neglecting his diabetes (disease), that may be very compelling to a member in the (pre-contemplation) stage of change. The topic in this example would be disease sequelae.

The ‘Topic’ element indicates what the content item is about. The ‘Disease’ element indicates which disease(s) the content item is relevant to; there may be multiple diseases. The disease-state element refers to the state of the individual with respect to disease(s), and indicates the member's interests in the treatments or risk factors for specific diseases, which disease screenings the member has taken, participation in prevention and wellness programs, disease-state, interests, what symptoms the member has, which diseases the member has been diagnosed with, which of the diagnosed diseases the member is being treated for, family history of diseases, and the state of control of the diagnosed diseases. A personal health risk assessment may also be included. The ‘Stage of Change’ element has to do with the behavioral stage of the member with respect to a specific health behavior. There are five stages of change: pre-contemplation (in which the member is not even thinking about a behavioral change such as going in for screenings), contemplation (in which the member starts thinking about screenings), decision (in which the member decides to go in for a particular screening), action (in which the member actually goes in for the screening) and maintenance (in which the member goes in for ongoing screenings on a regular basis as recommended by medical guidelines). The ‘Language’ element specifies the language of the content (English, Spanish, French, etc.). The ‘Readability’ element is based on whether the content can be understood by someone with a grade 8 education or less. The ‘Demographic-Appropriate’ element specifies whether the content item is age-appropriate, gender-oriented or neutral, or has affinity to a specific ethnic or racial background, or is relevant to a certain socio-economic status and so on. The idea is to categorize the content item in ways that enable the system to find the best suitable match to the member's own demographics.

Content items and variants of the same item may need to be stored in different formats in order to support multiple channels. Textual formats are useful for mail, email, and SMS transmission, but the SMS variant may be more condensed than the email version. Voice formats are useful for some people—the system can read the text and send it a landline phone. Similarly, for distribution via the internet using links, video and audio formats bring a lot of clarity. Content items are also ranked in terms of usefulness by members. Each content item includes a 5-point rating scheme on a scale of 1 to 5. Individual members enter the rating (at their option) to indicate whether the item was useful or not, and the aggregate score is used to rank the content item against other similar content items. In addition, content items also have variants representing different tones: negative polite, positive polite, bald, motivational, punitive and so on.

### PORTAL

As shown in FIG. 15, in one embodiment, the portal acts on the personalized intervention plan, and serves specific interventions via the designated channel to the designated member at the appointed time. The personalized intervention plan specifies, for a particular member, the various interventions that are mandatory and supplementary, and includes member-specific parameters for each intervention such as the channel, timing, frequency, tone, format and so on. The portal also acts as the conduit from the member's personal page to all the internet resources such as links to content, online communities, messages, and so on. In addition, the portal provides a mechanism by which member web behavior and responses to measuring interventions are gathered.

The initial interface to the member from the portal is through the personal page which contains an ordered list of proposed interventions comprising the member's intervention plan. The member modifications to the interventions are recorded and stored in the member history database. At any time, the member can access the system via the portal and make further modifications to the inputs, profile or interventions. After the interventions are served to the member, the member's behavior is observed in terms of the response to the intervention and the content, and in terms of interaction with the portal, i.e., web behavior.

A member's web behavior indicates the level of engagement. A highly engaged member will access the system on a frequent basis, click on the links provided and respond to ‘usefulness’ ratings embedded in the content. A highly engaged member may also modify interventions more frequently than those who are disinterested or not comfortable with the user interface. Member engagement is also indicated by their participation on online communities—whether they merely visit occasionally or whether they actively participate in terms of entering questions, answering other's questions, act as mentors to others, and so on.

Member responses to interventions are also recorded as they indicate member engagement as well. Whether the member responds to interventions by carrying out the actions requested, including keying in numbers on a keypad, whether the member responds to the embedded content usefulness entry and whether the member does this on a consistent basis all have a bearing on the member's level of engagement. There responses are collected via the portal through multiple channels and recorded in the operational database where it is held for a short term and then stored in the member history database for the long term.

### METHODS TO CAPTURE COMPLIANCE INFORMATION

### Compliance Tracking

Measurement interventions are used to capture compliance. A measurement intervention is typically in the form of a question to which the member is required to respond. If the SMS channel is used, a text message such as ‘Did you take your morning medicine today?’would be followed by a prompt: “Please enter 1 for yes or 0 for no’. If the member responds as requested, with a 1 or 0, then the system interprets the entries as answers to the specific measurement intervention and records the measurement in the operational database. Other types of questions are also possible, requiring a number to be keyed in. An example would be an SMS text measuring intervention ‘In the last 3 days how many doses did you miss?’ followed by a prompt: ‘Please enter a number using the keypad’. If the member responds to the intervention with a valid number (it cannot be greater then the total number of doses prescribed for the member), the system interprets the answer and records it in the operational database. In this embodiment, we are using this type of method known as a self-report, in which the individual directly answers the measuring interventions. In other embodiments, alternate ways of obtaining compliance data may be used. For example, medications may be dispensed in special containers instrumented with detection electronic circuitry that automatically transmit the time when the container was opened (the assumption is that the member actually consumed the drugs at the same time). These types of devices may be interfaced with the portal and compliance measurements may proceed automatically.

### MEMBER DATABASES

As shown in FIG. 2 and FIG. 3, in one embodiment, all the inputs and derived member factors are stored in secure member databases. This database is the source for the personalization and analytics.

### METHODS FOR HANDLING NON-RESPONSE

As shown in FIG. 16, in one embodiment the ‘Time Stamp’ algorithm determines the appointed time T₀ for a particular intervention and passes the command to the ‘Open Intervention’ algorithm that opens the particular intervention that is drawn from the intervention database. If the intervention is time-based, the algorithm records the time T_{O}; if the intervention is count-based, it records the zero count N₀; if the intervention is based on number of elapsed days, then the day count is zero'd. i.e., D₀. The ‘Record & Send’ algorithm stores the intervention record in the member history database and the portal then sends the intervention to the member. The ‘Open Intervention’ algorithm continues to monitor the elapsed time, count or days as applicable to the intervention. At the appointed time T₁, the system checks the operational database to see if there has been a response to the intervention. Similarly if the appointed count is N₁, or appointed days are D₁. If there has been a response, the intervention is closed. If there has been no response, the system invokes the escalation process.

Within the escalation process (see FIG. 17), there are different escalation procedures for different types of interventions. When there has been no response to an intervention at the first appointed time T₁, first appointed count N₁, or first appointed day D₁, depending on the type of the intervention. The appointed times T₁, T₂, T₃, T₄ appointed counts N₁, N₂, N₃, N₄, and appointed days D₁, D₂, D₃, D₄, are member specific parameters. The ‘Open Intervention’ algorithm calculates the elapsed time (T−T₀), elapsed count (N−N₀) and elapsed Days (D−D₀), depending on the type of intervention. For a time-based intervention, when the elapsed time has exceeded the member parameter T₂, the tone of the intervention is escalated to positive, then to a ‘bald’ tone when it has exceeded the member parameter T₃, and finally, when it has exceeded the member parameter T₄, the caregiver is notified. As an example, a reminder intervention (time-based) may begin with a neutral ‘It is time for your morning medicine’ at T₀, then escalate the tone to a positive-polite ‘If you haven't taken your morning medicine already, please take it now’, then to a bald ‘Please take your morning medicine now’. In a similar manner, for a count-based intervention, the number of times the intervention has been repeated (N−N₀) is tracked; at N₂, the intervention is sent to the alternate phone provided by the member, at N₃, the intervention is sent to the alternate contact (provided by the member, and could be an online mentor), and at N₄, the caregiver is notified. Similarly, for day-based interventions, at D₂, D₃ and D₄ the escalation is to change the intervention frequency, notify the caregiver and notify the provider, respectively.

Interventions are also adapted based on member non-response. FIG. 26a describes one embodiment of the intervention adaptation model. In this embodiment, the underlying premise is if an intervention is working, it should be continued but interventions that have stopped working should be changed. The decision may be driven by the compliance slope, as shown in this figure, but other indicators such as the trend in compliance slope may also drive the decision. If the slope is greater than zero, or zero, the intervention is working and will not be changed. If the slope is less than zero, the intervention is not working and will be replaced or changed in some way. Mandatory interventions will not be deleted but the frequency or timing may be changed (see below), but supplementary interventions can be replaced entirely. There is a larger list of candidate supplementary interventions that are ranked in different categories (disease criticality, usefulness, etc.) from which the top few are selected to be initially served. Based on member response, the system will automatically eliminate interventions that are being ignored and replace them with other interventions that may be ranked lower in the different categories. FIG. 26b describes another embodiment in which the frequency of the intervention is adapted to suit the member's preferences. In this embodiment, the underlying premise is that if a member does not respond to interventions (such as compliance measurements) every time, then the interventions are too frequent and should be made less frequent. There are other reasons for not responding, but in this embodiment, non-response is the criterion. Interventions are initially served at the current frequency, typically bi-weekly. If the member responds to instances of an intervention more than 75 percent of the time, the frequency is deemed to be matched to the member's preferences and the intervention frequency is continued. If the member response is less than 75 percent of the time, the intervention frequency is reduced.

### ANALYTICS

As shown in FIG. 18, in one embodiment, there are two major types of analytics, individual and aggregate. Member compliance data, stored in the member history database and other member inputs, stored in the member databases are inputs for the analytics. Individual analytics are performed on member-specific data that is de-identified but has pointers so that individual functions such as setting incentive payments for individual members may be performed. Aggregate analytics are performed on de-identified data without any pointers that can be used to trace the data back to any specific individual. Aggregate analytics are performed on data about groups of people in order to elicit group risk profiles, group improvements, drug consumptions, and so on.

### Individual Analytics

Member profile updates: one of the key uses of the member web behavior and intervention response data is to refine and update the member's profile. Members' preferences and profiles change over time. For example a member may be in a pre-contemplation stage of change at some point and as a result of multiple influencing interventions, may move to a contemplation or even action stage of change in a few weeks. Another member may have some painful symptoms at one point in time which may be alleviated by taking pain killers, with the pain gone, the member's state of health will be different in a matter of days. Clearly, a member's profile changes over time and needs to be updated periodically or whenever a change is detected, so that further interventions are based on the current profile and not the older one.

Compliance Slope: with reference to FIG. 22 which describes the method by which the compliance slope is derived from one set of measurements that are responses to a question such as ‘Have you taken your dose?’that requires a ‘Yes or No’ or ‘1 or 0’ answer. The member history database contains the historical responses to this measurement, including the current value and the previous value. If the current value is a ‘No’ and the previous value is a ‘Yes’, the compliance slope is deemed to be less than zero. If the current value is a ‘No’ and the previous value is also a ‘No’, the compliance slope is deemed to be zero. If the current value is a ‘Yes’ and the previous value is either a ‘Yes’ or a ‘No’, the compliance slope is deemed to be greater than zero. FIG. 23 describes the method by which the compliance slope is derived from a different set of measurements, namely, a question such as ‘How many doses did you miss in the last D days?’that requires a numeric response, typically 0 to 9. The response is converted to a D-day compliance rate. The member history database contains the historical responses to this measurement and the calculated compliance rates. The rate is considered to be low if more than 50 percent of the doses are missed (typically three out of six doses in a 3-day period), medium if between 18 percent and 49 percent of the doses are missed (typically two out of six doses in a 3-day period), and high if only 17 percent or less of the doses are missed (typically one or none of the six doses in a 3-day period). If the current rate is low and the previous rate is low, medium or high, the compliance slope is deemed to be less than or equal to zero. If the current rate is medium and the previous rate is high or medium, the compliance slope is also deemed to be less than or equal to zero. If the current rate is medium and the previous rate is low, the compliance slope is deemed to be greater than zero. If the current rate is high and the previous rate is low, medium or high, the compliance slope is deemed to be greater than zero.

Credibility Score: FIG. 20 describes the process by which the credibility score is derived. This is done on a continuous basis, being triggered whenever new information is recorded in the member history database. The credibility score is used to adjust the self-reported compliance information to compensate for the known over-estimation bias in self-reports. One determinant of the credibility score is the level of member engagement, as indicated by the number of member responses to interventions. The source of data for this process is the member history database, from which the responses to interventions are evaluated. If there is no response, the item score is a −1, and if there is a response, the item score is a +1. The number of non-responses and the number of responses are summed to provide one component of the credibility score. Another component of the credibility score comes from the member web behavior, which also indicates the level of the member's engagement with the system at a user-interface level. The more engaged the member, in terms of clicking on the links provided, participating in online communities, and so on, the higher this component of the credibility score. A third component of the credibility score comes from the member's clinical information which typically resides in external databases held by providers and physicians and is imported into the integration database, assuming the required permissions and access rights are in place. The specific clinical data of interest are the key indicators of disease control, such as serum cholesterol levels, glycosylated hemoglobin for diabetics, and so on. Regardless of the member's compliance self-reports, the true test is whether the desired health outcomes are achieved. If a member's diseases are being controlled, the relevant disease indicators should be within normal ranges. If these indicators are not within normal ranges, the item score is a −1, and if they are within normal ranges, the item score is a +1. The item scores are summed and incorporated into the credibility score. The underlying assumption is that higher compliance, if self-reported by the member, should be reflected in the clinical results that are closer to normal values. There are situations where a particular drug, even if taken exactly as directed, may not produce the desired clinical results; these are treated as exceptions. The credibility score determines an adjustment factor, which is qualitatively set at high, medium or low, and the adjustment factor is used to reduce the self-reported compliance responses by 0, 25 or 50 percent, as an example. These are system parameters that can be set externally.

PurpleTeal Score: FIG. 25 shows the inputs to the Member PurpleTeal Score. The PurpleTeal score is a figure of merit that characterizes a member's overall health behavior, similar to a person's credit-rating. It is a combination of several scores: screening compliance, medication compliance, treatment compliance, credibility and wellness compliance, and indicators: stage of compliance, response to interventions, response to content, community participation, calendar utilization, function utilization, web behavior, self management, and other indicators included in ‘Etc.’. The respective scores and indicators for a particular member are weighted, added and coded to yield the member's PurpleTeal score.

### Predictive Analytics—Expected Compliance

The member profile may be used to more accurately predict and manage risk. In one embodiment, the member profile is used to predict the expected compliance behavior which in turn can then be used as a baseline against which future actual compliance behavior may be compared. For example, based on a member's age, gender and race, the vulnerability mapping algorithm predicts that the member is susceptible to certain diseases and automatically generates screening oriented interventions for these diseases. At the same time, the affordability mapping algorithm, based on the member's income, family size and other factors, predicts that the member will not go for the screening and automatically generates enabling interventions to ease the cost through sponsored free screening events. Thus, inherent in the different mapping algorithms are predictions of expected compliance behavior. These elements are combined to yield an expected compliance profile for each member.

Predictive Analytics—Probability of Hospitalization

In another embodiment, the system provides analytics that use patient compliance data as a leading indicator to improve disease management programs. Patient compliance is treated as another vital sign that is captured on a regular basis. When a particular patient stops taking medicines it is only a matter of time before health problems become serious enough to warrant medical attention. Thus compliance data can be useful in identifying which patients are likely to require medical attention if left unattended and disease management programs can proactively stratify risks. Additionally, such patients can be contacted and asked to resume their medications in an attempt to stave off unnecessary medical treatments.

### Incentive Achievement Analytics

The system analyzes the database for compliance trends and history for individual patients. Subject to applicable privacy regulations, the trends and history may be provided to insurance companies, payers or managed-care organizations. These organizations may further use the information to structure incentives, such as rebates or premium adjustments, to improve the compliance performance of individual patients. This data may also be transmitted to providers for use in managing ‘Pay-for-Performance’ program incentives.

### Aggregate Analytics

Drug Consumption Analytics: current supply chain management systems can only track drugs to the pharmacy level. Once the prescriptions are filled and taken from the pharmacy, it is difficult to track consumption. Compliance data collected from individual members is aggregated into drug specific consumption patterns and used to predict future drug requirements. This analytic is provided to pharmaceutical manufacturers, distributors and pharmacies to enable timely and accurate supply replenishment and production forecasting.

Employee population expected compliance risk profile: this is a consolidation of the individual expected compliance analytics. Using this analytic, employers and others can examines groups of people, estimate their risks of non-compliance and structure overall incentive programs to improve compliance.

Risk reserve projections: since compliance is a leading indicator of the level of utilization of expensive health services, the population compliance risk profile is used to estimate the heath expenditures on a more current basis. This can be done monthly or more frequently and the risk reserve monies can be adjusted on a more frequent basis. This improves the accuracy of the risk reserve projections.

### REFERENCES:

Articles and links:
ref 1: CDC, WHO, ADA, etc. disease prevalence stats
ref 2. definition of loss ratio
ref3: medication compliance BCG study
ref4: medication compliance stats
ref 5 www.healthpages.com
ref 6 Prochaska
ref 7 CDC unscreened stats
ref 8 www.cdc.gov/nchs/nhis.htm
ref 9 Etiquette & Effectiveness: How Should a Smart Home Interact, Honeywell Laboratories, 2003
ref 10 Prochaska & DiClemente Stage of Change

Patents:
U.S. Pat. No. 5,642,731
U.S. Pat. No. 6,234,964
U.S. Pat. No. 6,770,029
U.S. Pat. No. 6974328

Applications:
0009398 26Jul2001 prescription compliance device and method of using device

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
maintaining a database of compliance information of individual medical patients;
analyzing a database for compliance trends and history for the individual patients;
providing information about the trends and history to an organization from the set consisting of an insurance company, a payer and a managed-care organization;
wherein the organization uses the information to structure incentives to improve compliance performance of the individual patients.

2. A method for reducing medical non-compliance, the method comprising:
developing the compliance-profile of a member,
using the profile to automatically generate a set of interventions,
categorizing, prioritizing and selecting the interventions,
incorporating the selected interventions into a personalized member user interface page,
serving the selected interventions to the member at the appropriate times via multiple channels,
observing and measuring member responses,
recording member responses in a database and analyzing the responses,
adapting the interventions, based on the analysis, to keep the member actively engaged,
escalating the interventions if the member response is inadequate, and
updating the member's compliance profile based on analysis of the database.
